(19) United States
(12) Patent Application Publication
(10) Pub. No.: US 2021/0269111 A1
(43) Pub. Date: Sep. 2, 2021

(54) SYSTEMS AND METHODS TO ASSIST BALANCING OF HUMAN-SUPPORTED VEHICLES

(71) Applicant: EVEsports, LLC, Treasure Island, FL (US)

(72) Inventor: Antonio Kotlar, Treasure Island, FL (US)

(21) Appl. No.: 17/261,511

(22) PCT Filed: Jul. 19, 2019
(86) PCT No.: PCT/US2019/042646

§ 371 Date: Jan. 19, 2021

Related U.S. Application Data
(60) Provisional application No. 62/701,291, filed on Jul. 20, 2018.

(51) Int. Cl. B62H 7/00; A63B 69/16; G09B 9/058

(52) U.S. Cl. CPC B62H 7/00; A63B 69/16; G09B 9/058; A63B 2220/16; A63B 2069/165; A63B 2069/162; A63B 2220/35; A63B 2069/167

(57) ABSTRACT

Vehicle simulators assist a rider with balancing a human-supported vehicle (e.g., bicycle, motorcycle, scooter, skateboard, etc.) by laterally displacing two pivot points supporting the vehicle without longitudinally moving the vehicle. The lateral displacement may be human-controlled, and need not require a wheel rolling on a belt or roller. The vehicle simulators feature mechanisms to laterally translate a front portion (e.g., a front wheel) and a rear portion (e.g., a rear wheel) of the vehicle such that a rider may balance the vehicle by steering. Advantageously, embodiments allow the vehicle to be laterally translated such that the rider may balance the vehicle in the same manner as when riding on a road, thereby providing a more realistic experience than prior-art simulators (e.g., stationary bicycle trainers) that do not allow the vehicle to be laterally translated and therefore do not require the rider to balance the vehicle.

### RELATED APPLICATION

This application claims priority to U.S. Provisional Application No. 62/701,291, filed Jul. 20, 2018, which is incorporated herein by reference in its entirety.

### BACKGROUND

Vehicle simulators replicate the experience of riding a human-supported vehicle (e.g., a bicycle or motorcycle) while keeping the vehicle stationary in the longitudinal, or fore/aft, direction. These trainers may be used for exercise, skills development, and physical therapy, and are particularly useful when riding outside is undesirable due to inclement weather. By keeping the vehicle longitudinally stationary, trainers may also be used to teach and develop safety skills before riding the vehicle in a non-stationary manner, such as on public roads and pathways. To aid with these uses, some trainers incorporate a virtual reality system that strives to provide to the rider a realistic experience that replicates the look and feel of riding in the real world.

One type of prior-art vehicle simulator is a bicycle trainer that clamps to a rear axle or frame of a bicycle, thereby providing the forces necessary to keep the bicycle upright without requiring the rider to balance the vehicle. A rear tire of the bicycle contacts a rear drum that is rotated by the rear wheel, when rotating via pedaling. The rear drum may also provide resistance to the rear wheel via magnetic, fluid, centrifugal, or other means, to simulate resistance encountered when riding outside. Typically, the front wheel of the bicycle does not rotate, remaining at rest. This type of indoor trainer may accommodate a wide variety of bicycle types and sizes, such as a bicycle sized according to the rider and to which the rider is accustomed to using.

Another type of prior-art vehicle simulator uses bicycle rollers. Unlike bicycle trainers, rollers do not affix to the bicycle frame or axle, and therefore the rider must actively balance the bicycle while pedaling. Typically, a set of rollers consists of two rear rollers that contact the rear wheel and are rotated by the rear wheel via pedaling, and one front roller that contacts the front wheel of the bicycle. A belt may connect the front roller with one of the rear rollers such that the front roller is rotated by the belt when pedaling. The spacing between the may be adjusted to match the bicycle's wheelbase, thereby accommodating a variety of bicycle types and sizes.

### SUMMARY OF THE EMBODIMENTS

Embodiments described herein are vehicle simulators for human-supported vehicles that help a rider balance the vehicle by laterally displacing two pivot points supporting the vehicle. Advantageously, lateral displacement may be human-controlled, and in some embodiments does not involve a wheel rolling on a belt or roller. Examples presented hereinbelow use a bicycle as the vehicle. However, embodiments may be used with another type of human-supported vehicle without departing from the scope hereof; examples of other such human-supported vehicles include motorcycles, scooters, skateboards, snowboards, surfboards, roller skates, boats (e.g., sculls), and skis.

A bicycle is one example of an inverted pendulum, a classic problem in dynamics and control theory in which the system is unstable, that is, the system will fall over under the influence of gravity. One strategy to stabilize an inverted pendulum (i.e., keep the system upright) affixes a pivot point of the system to a cart that moves laterally to remove a torque, induced by gravity, that tends to rotate the system around the pivot point to topple the system. One example of this strategy is balancing a stick on its end with one's hand: when the stick starts to fall, one may move his or her hand laterally to “catch” the stick such that it stays upright.

One aspect of the present embodiments is the realization that a vehicle may be balanced in a manner analogous to that of the stick, that is, by laterally displacing a pivot point beneath the vehicle to “catch” it when it starts to fall over. A bicycle, for example, has two pivot points, one under each of the front and rear wheels. By steering (e.g., turning the handlebars and fork of the bicycle), the rider introduces a lateral component to the velocity of the front pivot point, causing the front wheel to translate laterally. The lateral motion of the front wheel changes a heading of the bicycle frame, which in turn causes the rear wheel to laterally translate to follow the lateral translation of the front wheel. This series of lateral motions balances the bicycle, preventing it from falling over.

Advantageously, embodiments herein allow the vehicle to be laterally translated such that the rider may balance the vehicle in the same manner as when riding the vehicle without the simulator (e.g., on a road). Embodiments therefore provide a more realistic experience than prior-art simulators that do not allow the vehicle to be laterally translated and therefore do not require the rider to balance the vehicle (e.g., bicycle trainers). Furthermore, certain embodiments allow simulation of wind resistance, inclination, and road surface conditions.

Other prior-art exercise bicycles and motorcycle simulators may allow the rider to lean the vehicle, but include springs and/or actuators to hold and return the vehicle upright. One such simulator was developed in the 1960s by Stassen and Van Lunteren at the Delft University of Technology in the Netherlands. In this system, the pivot points of the vehicle were fixed in location, and hydraulic actuators were used to tilt the bicycle frame left and right. Such motion does not match the actual feel of riding and balancing a bicycle on a road or surface, which is subjected to zero torques about the ground contact line connecting the two pivot points (except in the case of training wheels). Cossalter discloses a tiltable motorcycle frame that is controlled similarly to methods of Stassen and van Lunteren.

U.S. Pat. No. 4,978,300 discloses a roll actuator assembly (see column 5). U.S. Pat. No. 5,547,382 discloses a rolling shaft driven by tilt motor. U.S. Pat. No. 6,733,294 fails to disclose balancing. U.S. Pat. No. 6,030,223 discloses a tilt shaft that is positioned higher up the vehicle (like sitting on a fence) and requires that the rider tip using arms. U.S. Pat. No. 6,234,800 discloses a four-bar linkage rather than pivot shaft; however, it is stable like a pendulum so there is no need for the rider to balance the vehicle.

Embodiments described herein improve on prior-art bicycle rollers, as described above, by supporting each wheel at a single point. Unlike bicycle trainers, bicycle rollers allow the front and rear wheels of the bicycle to laterally translate. However, the use of two rear rollers, needed to longitudinally constrain the motion of the bicycle, also creates double contacts on the rear wheel that do not accurately mimic the forces applied to a single ground contact point of the rear wheel, such as when riding the bicycle on a road. Furthermore, some riders position the front roller to support the front wheel in front of the ground contact point, resulting in a force on the front wheel that differs from the force that would be applied to the ground contact point when riding the bicycle on a road. For these reasons, embodiments described herein provide a more realistic feeling to riders of the vehicle as compared to rollers.

Similar lateral translations may be achieved by riding the bicycle on a moving belt, such as a treadmill. The belt accurately recreates the physics of balancing by contacting each wheel at a single ground contact point. However, the use of a fast-moving belt provides a serious risk of injury to both rider and observer.

In a first aspect, a vehicle simulator to assist balancing of a vehicle includes a front translation mechanism that supports a front portion of the vehicle and laterally translates the front portion to change a heading of a rear portion of the vehicle in response to steering of the vehicle. The vehicle simulator also includes a rear translation mechanism that supports the rear portion and laterally translates the rear portion in response to the change of heading, and a longitudinal restraint mechanism configured to physically couple with the vehicle to longitudinally constrain the vehicle.

In certain embodiments of the first aspect, the front portion of the vehicle includes a front wheel, and the rear portion of the vehicle includes a rear wheel. The front translation mechanism has a front surface longitudinally movable to rotate the front wheel, wherein the rotating front wheel laterally translates along the moving front surface in response to the steering. The rear translation mechanism has a rear surface longitudinally moveable by the rear wheel, when rotating, wherein the rotating rear wheel laterally translates along the moving rear surface in response to the change of heading.

In certain embodiments of the first aspect, the vehicle simulator further includes a linear guide that restrains movement of the longitudinal restraint mechanism to a lateral guide axis.

In certain embodiments of the first aspect, the vehicle simulator further includes a drive belt mechanically coupled to move the front surface at a longitudinal speed similar to a longitudinal speed of the rear surface.

In certain embodiments of the first aspect, the vehicle simulator further includes a motor physically coupled to longitudinally move the front surface, a rear speed sensor that outputs a rear longitudinal speed signal in response to the rear surface moving, a front speed sensor that outputs a front longitudinal speed signal in response to the front surface moving, and a controller that receives the front and rear longitudinal speed signals and controls the motor to move the front surface according to the front and rear longitudinal speed signals.

In certain embodiments of the first aspect, the controller is configured to control the motor to move the front surface such that the front longitudinal speed signal follows the rear longitudinal speed signal.

In certain embodiments of the first aspect, the vehicle simulator further includes a resistance generator that resists longitudinal motion of the rear surface.

In certain embodiments of the first aspect, the resistance generator includes an electric motor physically coupled with the rear surface and controllable, by the controller, in a motoring mode and a generator mode.

In certain embodiments of the first aspect, the vehicle simulator further includes a torque sensor that outputs a torque signal in response to a torque of the electric motor, wherein the controller is configured to control the electric motor such that the torque signal follows a torque setpoint.

In certain embodiments of the first aspect, the controller is further configured to algorithmically select the torque setpoint according to a model of a rolling resistance force between the rear wheel and a surface such that the torque simulates the rolling resistance force.

In certain embodiments of the first aspect, the controller is further configured to algorithmically select the torque setpoint according to a model of a drag force such that the torque simulates the drag force.

In certain embodiments of the first aspect, the vehicle is a bicycle and the longitudinal restraint mechanism includes an arm having a variable length, and a top joint coupled with a top end of the arm and configured to physically couple with the bicycle, the top joint having a top axis parallel to a lean axis of the bicycle. The longitudinal restraint mechanism also includes a bottom joint physically coupled with a bottom end of the arm and having a bottom axis parallel to the lean axis, and a turntable that supports the linear guide and the bottom joint, and is rotatable about a vertically-oriented turntable axis in response to the changing heading. When the bicycle leans, the arm pivots at the top axis and the bottom axis, and the length of the arm changes to allow the arm to remain parallel to a plane of the rear wheel.

In certain embodiments of the first aspect, the turntable axis is aligned with a ground contact point of the rear wheel.

In certain embodiments of the first aspect, the top joint is configured to physically couple with an axle of the rear wheel.

In certain embodiments of the first aspect, the top joint is configured to physically couple with a frame of the bicycle.

In certain embodiments of the first aspect, the front surface includes a front roller, and the vehicle simulator further includes an adjustable spacer that longitudinally positions the front roller to support a ground contact point of the front wheel.

In certain embodiments of the first aspect, the vehicle is a bicycle and the longitudinal restraint mechanism includes an arm, and a joint, coupling a first end of the arm with the linear guide, that allows the arm to (a) rotate around the guide axis, (b) pivot about a pivot axis perpendicular to the guide axis, and (c) twist about a longitudinal axis of the arm. The longitudinal restraint mechanism also includes a rolling-element bearing, coupling a second end of the arm with the bicycle, that allows the arm to rotate about a rotation axis of the rear wheel. When the bicycle leans: (a) the arm twists about the longitudinal axis, (b) the second end of the arm rotates about the rotation axis of the rear wheel, and (c) the first end of the arm rotates about the guide axis and pivots at the pivot axis, such that the arm remains parallel to a plane of the rear wheel.

In certain embodiments of the first aspect, the rolling-element bearing is configured to physically couple with an axle of the rear wheel.

In certain embodiments of the first aspect, the rolling-element bearing is configured to physically couple with a frame of the bicycle.

In certain embodiments of the first aspect, the front surface includes a front roller, and the vehicle simulator further includes an adjustable spacer that longitudinally positions the front roller to support a ground contact point of the front wheel.

In certain embodiments of the first aspect, the front translation mechanism includes a front carriage having a front joint configured to support the vehicle at the front portion, rotate about a front lean axis, and rotate about a front heading axis. The front translation mechanism also includes a steering sensor that senses a front heading angle of the front joint about the front heading axis, and a front actuator that laterally translates the front carriage. The rear translation mechanism includes a rear carriage having a rear joint configured to support the vehicle at the rear portion, rotate about a rear lean axis, and rotate about a rear heading axis. The rear translation mechanism also includes a rear actuator that laterally translates the rear translation mechanism. The vehicle simulator further includes a controller that algorithmically determines front and rear lateral velocities based on the front and rear heading angles, respectively, and a nominal forward speed. The controller, in response to the steering of the vehicle, controls the front and rear actuators to laterally translate the respective front and rear carriages according to the respective front and rear lateral velocities.

In certain embodiments of the first aspect, the vehicle simulator further includes a front lean sensor that measures a front lean angle of the front joint around the front lean axis. The controller is further configured to algorithmically determine a front lateral acceleration based on the front lean angle, and to control the front actuator to laterally accelerate the front carriage according to the front lateral acceleration.

In certain embodiments of the first aspect, the vehicle simulator further includes a rear lean sensor that measures a rear lean angle of the rear joint around the rear lean axis. The controller is further configured to algorithmically determine a rear lateral acceleration based on the rear lean angle, and to control the rear actuator to laterally accelerate the rear carriage according to the rear lateral acceleration.

In certain embodiments of the first aspect, the controller includes a switch that responds to an external signal to transition operation of the controller between an acceleration-based control mode and a velocity-based control mode.

In certain embodiments of the first aspect, the vehicle is a bicycle, the front joint is configured to support a front wheel of the bicycle, and the rear joint is configured to support a rear wheel of the bicycle.

In certain embodiments of the first aspect, the vehicle is a bicycle, the front joint is configured to support a front fork of the bicycle, and the rear joint is configured to support the rear portion of the bicycle via dropouts of the bicycle.

In certain embodiments of the first aspect, the vehicle includes a bicycle mounted to a stationary trainer that supports the bicycle and allows a rider to pedal the bicycle, wherein the front portion includes a front wheel of the bicycle. The front translation mechanism includes a front roller that rotates the front wheel of the bicycle such that the front wheel laterally translates along the front roller. The rear translation mechanism includes a rear platform having an upper surface that supports the trainer, a rotatable transfer wheel affixed to a lower surface of the rear platform to support the rear platform, and a turntable to allow the rear platform to rotate about a vertically-oriented turntable axis in response to the change of heading. The rear translation mechanism also includes a rotatable rear drum that supports and rotates the transfer wheel, the rear drum having a rotation axis parallel to a rotation axis of the front roller. The rear translation mechanism includes a linear guide coupled with the rear platform and configured to allow the rear platform to translate laterally without translating longitudinally and vertically. The transfer wheel, in response to the change of heading, laterally translates along the rotating rear drum to translate the rear platform laterally along the linear guide.

In certain embodiments of the first aspect, the rear platform further includes a rolling-element bearing that physically couples the transfer wheel with the lower surface of the rear platform, and allows the rear platform to lean about a lean axis parallel to a lean axis of the bicycle.

In certain embodiments of the first aspect, the turntable axis coincides with a ground contact point of a rear wheel of the bicycle.

In certain embodiments of the first aspect, the upper surface of the rear platform is configured to position a ground contact point of a rear wheel of the bicycle above the transfer wheel.

In certain embodiments of the first aspect, the vehicle simulator further includes an adjustable spacer that longitudinally positions the front roller such that the front roller contacts a ground contact point of the front wheel.

In certain embodiments of the first aspect, the vehicle simulator further includes a first motor that rotates the front roller, and a second motor that rotates the rear drum.

In certain embodiments of the first aspect, the vehicle simulator further includes a drive belt that mechanically couples the rear drum and the front roller, and a motor that rotates one of the front roller and the rear drum.

In certain embodiments of the first aspect, the vehicle simulator further includes at least one spring positioned to apply a restoring force that returns the rear platform to a horizontal orientation when a leaning force is removed.

In certain embodiments of the first aspect, the at least one spring includes vertically-oriented first and second springs, a top end of each of the first and second springs being affixed to the lower surface of the rear platform, a bottom end of each of the first and second springs being affixed to the turntable, and the first and second springs being laterally positioned equidistant from, and on opposite sides of, a bearing axis.

In a second aspect, a method to assist balancing of a human-supported vehicle includes longitudinally moving a front surface, supporting a front wheel of the vehicle at a ground contact point of the front wheel, to rotate the front wheel such that the rotating front wheel translates laterally along the moving front surface to change a heading of a rear wheel of the vehicle in response to steering of the vehicle. The method also includes supporting the rear wheel with a rear surface at a ground contact point of the rear wheel, wherein the rear surface is moved longitudinally by the rear wheel, when rotating, such that the rear wheel translates laterally along the moving rear surface in response to the change of heading. The method also includes longitudinally constraining the vehicle without lateral constraint.

In certain embodiments of the second aspect, the method further includes sensing a rear longitudinal speed of the rear surface, wherein said longitudinally moving the front surface includes moving the front surface at a front longitudinal speed based at least in part on the rear longitudinal speed.

In certain embodiments of the second aspect, the method further includes resisting the longitudinal motion of the rear surface to simulate resistance forces.

In certain embodiments of the second aspect, said resisting the longitudinal motion includes resisting the longitudinal motion to simulate a rolling resistance force according to a model of the rolling resistance force between the rear wheel and a surface.

In certain embodiments of the second aspect, said resisting the longitudinal motion includes resisting the longitudinal motion to simulate a drag force according to a model of the drag force.

In a third aspect, a method to assist balancing of a human-supported vehicle includes laterally translating a front portion of the vehicle to change a heading of a rear portion of the vehicle in response to steering of the vehicle, and laterally translating the rear portion of the vehicle in response to the change of heading such that the rear portion laterally follows the front portion.

In certain embodiments of the third aspect, the method further includes longitudinally constraining the vehicle.

In certain embodiments of the third aspect, said laterally translating the front portion of the vehicle includes sensing a front heading angle of the front portion of the vehicle, algorithmically determining a front lateral velocity based on the front heading angle and a nominal forward speed, and controlling a front actuator to laterally translate a front carriage at the front lateral velocity, the front carriage supporting the front portion of the vehicle. Said laterally translating the rear portion includes sensing a rear heading angle of the rear portion of the vehicle, algorithmically determining a rear lateral velocity based on the rear heading angle and the nominal forward speed, and controlling a rear actuator to laterally translate a rear carriage at the rear lateral velocity, the rear carriage supporting the rear portion of the vehicle.

In certain embodiments of the third aspect, said algorithmically determining the front lateral velocity includes algorithmically determining the front lateral velocity according to an equation v_{y}=v·sin θ_{f}, where v_{y} is the front lateral velocity, v is the nominal forward speed, and θ_{f} is the front heading angle. Said algorithmically determining the rear lateral velocity includes algorithmically determining the rear lateral velocity according to an equation v_{y}=v·sin θᵣ, where v_{y} is the rear lateral velocity and θᵣ is the rear heading angle.

In certain embodiments of the third aspect, the vehicle includes a bicycle, and the method further includes determining the nominal forward speed from a pedaling rate of a rider of the bicycle.

In certain embodiments of the third aspect, the front and rear portions of the vehicle include a front fork and a frame of a bicycle, respectively. The method further includes supporting the front fork and the frame.

In certain embodiments of the third aspect, the vehicle includes a bicycle having the rear portion affixed to a stationary trainer. Said laterally translating the front portion of the vehicle includes longitudinally moving a front surface, supporting a front wheel of the bicycle at a ground contact point of the front wheel, to rotate the front wheel such that the rotating front wheel translates laterally along the moving front surface to change a heading of the rear portion. Said laterally translating the rear portion of the vehicle includes longitudinally moving a rear surface supporting a transfer wheel affixed to a lower surface of a platform supporting the stationary trainer, the moving rear surface rotating the transfer wheel to laterally translate the transfer wheel along the moving rear surface in response to the change of heading.

In certain embodiments of the third aspect, the method further includes applying a restoring force to the platform to return the platform to a horizontal orientation when a leaning force is removed.

### BRIEF DESCRIPTION OF THE FIGURES

FIG. 1 is a side view of an inverted pendulum attached to a cart by a pivot.

FIG. 2 is a front view of a stationary, upright wheel that is an example of an inverted pendulum.

FIGS. 3 and 4 are side and top views, respectively, of the wheel of FIG. 2 rolling in the x direction with a speed v on a flat surface.

FIG. 5 is a top view of the wheel of FIG. 2, rotated in an x-y plane by a heading angle θ around a vertical heading axis that coincides with a contact point.

FIGS. 6 and 7 are side and top views, respectively, of a bicycle being balanced by laterally moving a front wheel and a rear wheel of the bicycle.

FIG. 8 is a perspective view of a vehicle simulator that laterally translates a vehicle such that a rider can balance the vehicle by steering, in an embodiment.

FIGS. 9 and 10 are front and top views, respectively, of a front translation mechanism of the vehicle simulator of FIG. 8, in embodiments.

FIG. 11 is a side view showing a vehicle simulator being used with the bicycle of FIG. 6, in an embodiment.

FIG. 12 is a flow chart illustrating a method for controlling lateral movement of a carriage via an actuator, in embodiments.

FIG. 13 is a flow chart illustrating a method to assist balancing of a human-supported vehicle, in embodiments.

FIGS. 14, 15, and 16 are perspective, top, and rear views, respectively, of a vehicle simulator that advantageously replicates riding the bicycle of FIG. 6 on a road by supporting each of the front and rear wheels of the bicycle at a single contact point, in an embodiment.

FIGS. 17, 18, and 19 are perspective, side, and rear views, respectively, of another vehicle simulator that advantageously replicates riding the bicycle of FIG. 6 on a road by supporting each of the front and rear wheels of the bicycle at a single contact point, in an embodiment.

FIG. 20 is a flow chart illustrating a method for controlling a resistance generator to simulate drag, in embodiments.

FIG. 21 is a flow chart illustrating a method for controlling a resistance generator to simulate rolling resistance of the bicycle of FIG. 6 riding on a road, in embodiments.

FIG. 22 is a flow chart illustrating a method for controlling a resistance generator to simulate more than one resistance force simultaneously, in embodiments.

FIG. 23 is a flow chart illustrating a method for controlling a resistance generator to simulate changing riding conditions, in embodiments.

FIG. 24 is a flow chart illustrating a method to assist balancing of a human-supported vehicle, in embodiments.

FIG. 25 is a perspective view of a vehicle simulator that works with the bicycle of FIG. 6 affixed to a stationary trainer, in an embodiment.

FIGS. 26 and 27 are top and rear views, respectively, of a rear translation mechanism, of the vehicle simulator of FIG. 25, that laterally moves a platform supporting the stationary trainer of FIG. 25, in an embodiment.

FIG. 28 is a schematic diagram showing components and functionality of a controller that may be used with embodiments herein.

### DETAILED DESCRIPTION OF THE EMBODIMENTS

Balancing an Inverted Pendulum

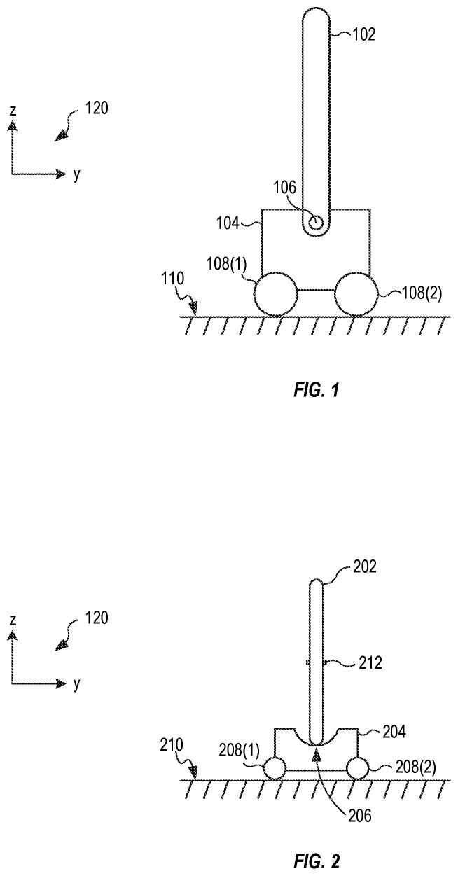

FIG. 1 is a side view of an inverted pendulum 102 attached to a cart 104 by a pivot 106. Cart 104 is mounted on wheels 108 that move laterally along a flat surface 110 in a horizontal y direction (see right-handed coordinate system 120). Inverted pendulum 102 is unstable when cart 104 is stationary. That is, when inverted pendulum 102 is displaced an arbitrarily small amount from an upright orientation (i.e., parallel to a z direction, as shown in FIG. 1), a downward gravitational force acting on a center-of-mass of inverted pendulum 102 creates a torque that rotates inverted pendulum 102 around pivot 106 such that inverted pendulum 102 topples. To stabilize inverted pendulum 102, cart 104 may be laterally moved to remove the gravitational torque, or “catch” inverted pendulum 102 before it topples. This process may be repeated such that each time inverted pendulum 102 begins to topple, cart 104 laterally moves to return inverted pendulum 102 to the upright orientation, thus balancing inverted pendulum 102.

The above technique to balance inverted pendulum 102 moves cart 104 laterally back-and-forth, according to the direction in which inverted pendulum 102 begins to topple. Thus, a lateral velocity of cart 104 changes in time, resulting in a lateral acceleration. Cart 104 must laterally accelerate to balance inverted pendulum 102.

FIG. 2 is a front view of a stationary, upright wheel 202 that is an example of an inverted pendulum. Wheel 202 has an axle 212 parallel to the y direction (see coordinate system 120) such that wheel 202 is oriented to roll in an x direction. Wheel 202 is supported at a contact point 206 by a cart 204 with wheels 208 that move laterally along a flat surface 210 in the y direction. Wheel 202 may rotate in a y-z plane around contact point 206, similarly to how inverted pendulum 102 of FIG. 1 rotates around pivot 106.

Wheel 202 is unstable when not rolling and cart 204 is stationary. That is, wheel 202 will be rotated around contact point 206 by a gravitationally-induced torque so as to topple. Wheel 202 may be balanced by laterally moving cart 204 to position contact point 206 beneath a center-of-mass of wheel 202, thereby eliminating the gravitationally-induced torque by eliminating its moment arm. Thus, balancing of wheel 202 is like balancing of inverted pendulum 102 of FIG. 1.

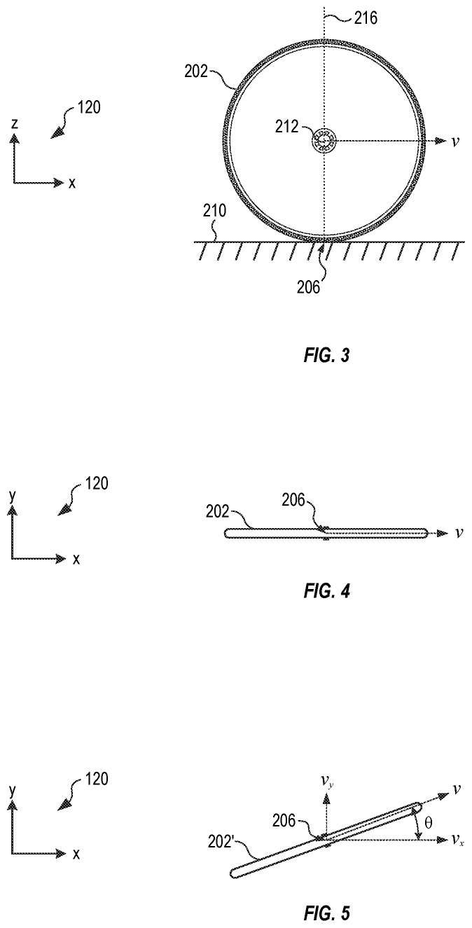

FIGS. 3 and 4 are side and top views, respectively, of wheel 202 rolling in the x direction with a speed v on flat surface 210. FIG. 5 is a top view of wheel 202, shown as wheel 202′, rotated in an x-y plane by a heading angle θ around a vertical heading axis 216 that coincides with contact point 206. The heading angle θ is measured with respect to the positive x direction. In FIGS. 3 and 4, wheel 202 has zero lateral velocity v_{y} in the y direction, and therefore has a longitudinal velocity vₓ in the x direction equal to the speed v, where v=\sqrt{vₓ²+v_{y}²}. When wheel 202 is rotated by the heading angle θ to become wheel 202′ of FIG. 5, the lateral velocity is increased to v_{y}=v×sin θ, and the longitudinal velocity is decreased to vₓ=v×cos θ. That is, changing a heading of wheel 202 changes only a direction of wheel 202, not the speed v. Furthermore, the change in lateral velocity from v_{y}=0 in FIGS. 3 and 4 to v_{y}=v×sin θ in FIG. 5 corresponds to a lateral acceleration.

Three types of wheel rotation are referred to herein: (1) rotation of a wheel about its axle, (2) rotation of a wheel to change its heading angle, and (3) rotation of a wheel to change its lean angle. Unless otherwise indicated, rotation of a wheel refers the first type. For example, wheel 202 undergoes this first type of rotation when rolling along flat surface 210, as shown in FIG. 3. The second and third types of wheel rotation can be identified by reference to a specific rotation axis about which the wheel rotates.

FIGS. 3, 4, and 5 illustrate how the lateral motion used to balance wheel 202 in FIG. 2 may be generated without cart 204 when wheel 202 rolls on flat surface 210. Wheel 202 couples the longitudinal velocity vₓ and the lateral velocity v_{y} with a coupling strength determined by the heading angle θ. Thus, steering of rear wheel 202 (i.e., changing the heading angle θ) converts some of the longitudinal velocity vₓ to the lateral velocity v_{y} for balancing wheel 202, thereby changing the lateral velocity according to a lateral acceleration. This combination of changing longitudinal and lateral motions results in wheel 202 tracing out a curve on flat surface 210.

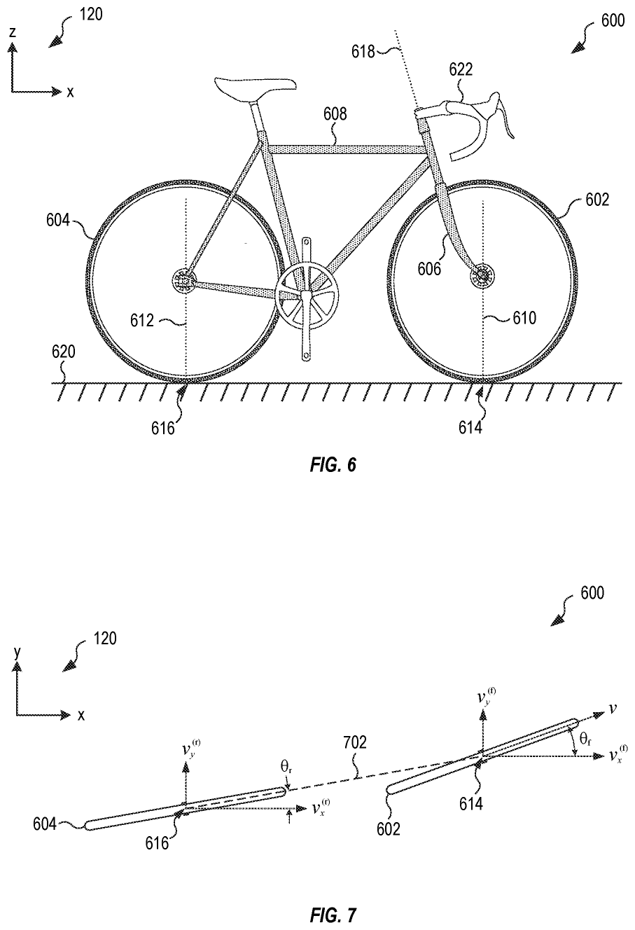

FIGS. 6 and 7 are side and top views, respectively, of a bicycle 600 being balanced by laterally moving a front wheel 602 and a rear wheel 604 of bicycle 600. Bicycle 600 is one example of a single-track vehicle that is an inverted pendulum. Bicycle 600 is laterally unstable, and without balancing will lean about a lean axis 702 that coincides with a line joining front and rear contact points 614, 616. In FIGS. 6 and 7, lean axis 702 is horizontal (i.e., lying in the x-y plane; see right-handed coordinate system 120) when front and rear contact points 614, 616 are located at the same z position. However, lean axis 702 may be tilted when a flat surface 620 supporting wheels 602 and 604 is inclined, such as on the side of a hill. Lean axis 702 defines the rear heading angle θ, of rear wheel 604 with respect to the positive x direction. Front contact point 614 refers to a center of a front contact area between front wheel 602 and flat surface 620, and rear contact point 616 refers to a center of a rear contact area between rear wheel 604 and flat surface 620. A size of the front and rear contact areas depends on properties of wheels 602, 604 (e.g., a type of rubber used for tires mounted on wheels 602 and 604, tire pressure, tire width, etc.).

Bicycle 600 may be balanced by laterally moving (e.g., accelerating) front and rear wheels 602, 604 to position respective contact points 614, 616 beneath the corresponding wheels. Each wheel 602, 604 of bicycle 600 follows the dynamics of wheel 202, as discussed for FIGS. 2-5. That is, bicycle 600, when front and rear wheels 602, 604 rotate (e.g., via pedaling) to move bicycle 600 along surface 620 at a speed v, may be balanced by (i) changing a front heading angle θ_{f} of front wheel 602 to generate a front lateral acceleration that laterally displaces front wheel 602, and (ii) changing the rear heading angle θ, of rear wheel 604 to generate a rear lateral acceleration that laterally displaces rear wheel 604.

In the example of FIGS. 6 and 7, bicycle 600 is steered via handlebars 622 to rotate a fork 606 around a steering axis 618, thereby rotating front wheel 602 by the front heading angle θ_{f} around a vertical front support axis 610 that coincides with front contact point 614. In response to the steering, front wheel 602 and fork 606 laterally translate to rotate a frame 608 of bicycle 600 around a vertical rear support axis 612 that coincides with rear contact point 616, thereby changing a heading of frame 608 and the orientation of lean axis 702 in the x-y plane. A rotation plane of rear wheel 604 coincides with a lateral symmetry plane of frame 608, and therefore the changing heading of frame 608 changes the rear heading angle θ, likewise. For clarity, FIG. 7 does not show frame 608, fork 606, and handlebars 622.

Bicycle 600 is longitudinally stationary (i.e., vₓ=0) when used with the embodiments described herein. To balance bicycle 600 with some embodiments, front and rear heading angles θ_{f}, θᵣ may be measured to determine the corresponding lateral velocities v_{y}^{(f)}=v×sin θ_{f} and v_{y}^{(r)}=v×sin θᵣ, for a given speed v. Front and rear wheels 602, 604 may then be laterally moved according to the corresponding front and rear lateral velocities v_{y}^{(f)} and v_{y}^{(r)}. Bicycle 600 can then be balanced by steering handlebars 622 to change the front heading angle θ_{f}, in turn (i) generating a front lateral acceleration that laterally moves front wheel 602, and (ii) changing the rear heading angle θᵣ to generate a rear lateral acceleration that laterally moves rear wheel 604. When θ_{f} and θᵣ are small (e.g., limited to a range of ±10°), vᵣ^{(f)} may be approximated by v×θ_{f}, and v_{y}^{(f)} may be approximated by v×θᵣ.

Embodiments without Rotating Wheels

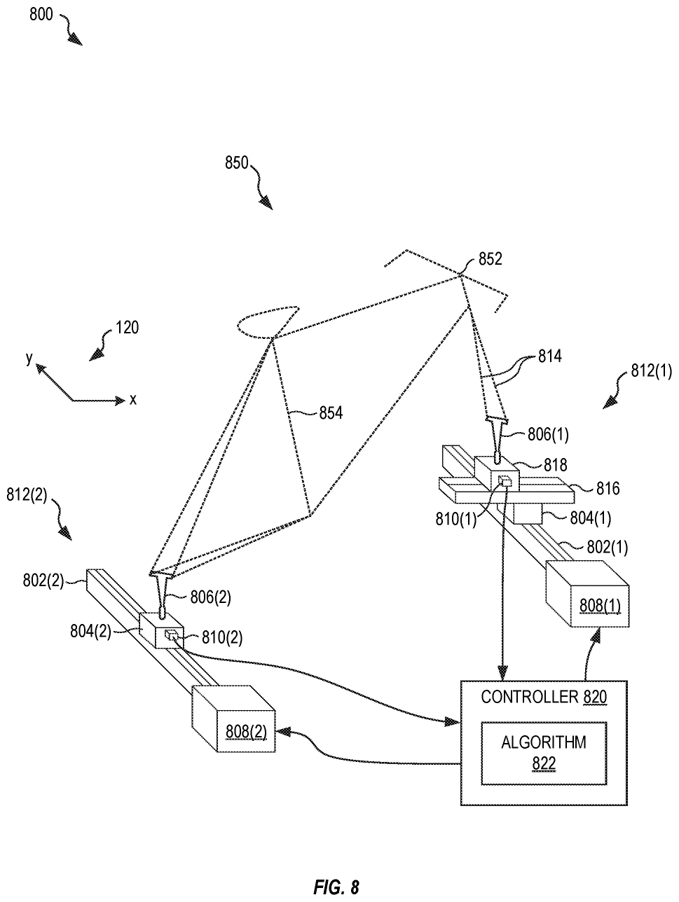

FIG. 8 is a perspective view of a vehicle simulator 800 that laterally translates a vehicle such that a rider can balance the vehicle by steering. Advantageously, simulator 800 recreates the effects of riding the vehicle on a flat surface (e.g., surface 620 of FIG. 6). In the example of FIG. 8, the vehicle is a bicycle 850 with no wheels; another type of vehicle (e.g., skateboard, snowboard, bicycle with wheels) may also be used without departing from the scope hereof. Simulator 800 includes a front translation mechanism 812(1) that supports a front portion of bicycle 850 and laterally translates the front portion in response to steering of bicycle 850. Front translation mechanism 812(1) includes a rail 802(1) oriented such that a front carriage 804(1) is laterally movable along rail 802(1) in the y direction (see coordinate system 120). Carriage 804(1) supports a longitudinal rail 816 along which a fork carriage 818 is longitudinally moveable. The front portion of bicycle 850 is a fork 814 that normally connects to a front wheel (e.g., front wheel 602 of FIGS. 6 and 7). Fork carriage 818 supports the front portion of bicycle 850 with a front adapter 806(1) that affixes to fork 814.

Vehicle simulator 800 also includes a rear translation mechanism 812(2) that supports a rear portion of bicycle 850 and laterally translates the rear portion in response to a heading of the rear portion of bicycle 850. Rear translation mechanism 812(2) includes a rail 802(2) aligned such that a rear carriage 804(2) is laterally movable along rail 802(2) in the y direction. In the example of FIG. 8, the rear portion of bicycle 850 is a frame 854 that normally connects to a rear wheel (e.g., rear wheel 604 of FIGS. 6 and 7). Carriage 804(2) supports the rear portion of bicycle 850 with an adapter 806(2) configured to affix to rear dropouts of bicycle 850. In FIG. 8, carriages 804(1) and 804(2) are positioned such that bicycle 850 is centered on rails 802(1) and 802(2); carriages 804(1) and 804(2) may not remain centered on respective rails 802(1) and 802(2) when moving laterally in response to steering.

Each of adapters 806(1) and 806(2) includes a joint that allows bicycle 850 to lean. That is, bicycle 850 is not supported laterally and may topple sideways when not balanced or stabilized. Furthermore, front adapter 806(1) is rotatable about a vertical front support axis parallel to the z direction (e.g., front support axis 610 of FIGS. 6 and 7) such that handlebars 852 and fork 814 can be turned to steer bicycle 850, changing a heading of fork 814. Similarly, rear adapter 806(2) is rotatable about a vertical rear support axis (e.g., rear support axis 612 of FIGS. 6 and 7) such that the heading of frame 854 can change.

A controller 820 controls front and rear actuators 808(1) and 808(2) to laterally move carriages 804(1) and 804(2) along rails 802(1) and 802(2), respectively. Fork carriage 818 has a front heading sensor 810(1) that senses a front heading angle of fork 814. Rear carriage 804(2) has a rear heading sensor 810(2) that senses a rear heading angle of frame 854. Thus, heading sensors 810 effectively measure the heading angles of front and rear wheels of bicycle 850, as if the front and rear wheels were affixed to bicycle 850 in the conventional manner. That is, the heading angle of fork 814 corresponds to the front heading angle θ_{f} of front wheel 602 of FIGS. 6 and 7, and the heading angle of frame 854 corresponds to the rear heading angle θ, of rear wheel 604 of FIGS. 6 and 7.

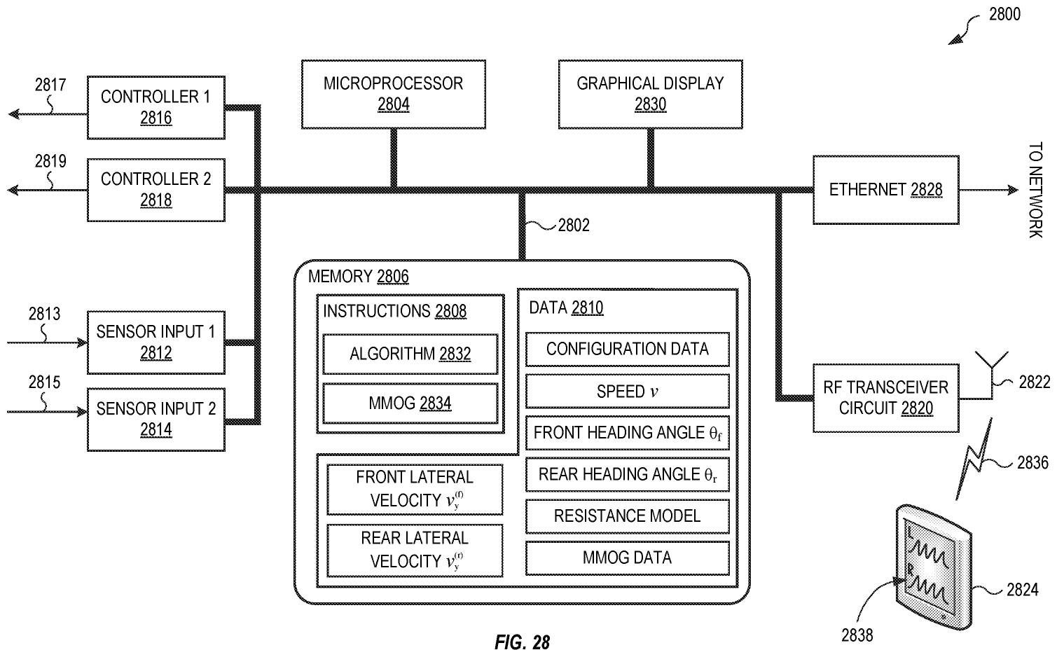

Controller 820 includes a processor, memory, and interface hardware that controls actuators 808 and receives sensed heading angles from sensors 810. An algorithm 822 (e.g., see algorithm 2832 in FIG. 28) of controller 820 includes machine-readable instructions that, when executed by the processor of controller 820, control the processor to: (i) determine a front lateral velocity v_{y}^{(f)} based on the speed v and the sensed heading angle received from front heading sensor 810(1), (ii) determine a rear lateral velocity v_{y}^{(r)} based on the speed v and the sensed heading angle received from rear heading sensor 810(2), (iii) control front actuator 808(1) to move front carriage 804(1) according to the front lateral velocity v_{y}^{(f)}, and (iv) control rear actuator 808(2) to move rear carriage 804(2) according to the rear lateral velocity v_{y}^{(r)}.

As an example of algorithm 822, when handlebars 852 are turned clockwise (about the z-axis, as viewed from above) the heading angle sensed by front heading sensor 810(1) decreases, causing controller 820 to control actuator 808(1) to move front carriage 804(1) in the negative y direction (see coordinate system 120). As front carriage 804(1) moves, the heading angle sensed by rear heading sensor 810(2) also decreases and thus controller 820 controls rear actuator 808(2) to also move rear carriage 804(2) in the negative y direction.

Controller 820 may also store and/or determine the speed v. In one embodiment, a user (e.g., a rider of bicycle 850) enters the speed v to controller 820, where it is stored in memory and used by algorithm 822 to determine the lateral velocities v_{y}^{(f)} and v_{y}^{(r)}. The user may enter the speed v to controller 820 via a graphical user interface of controller 820, or wirelessly (e.g., via Bluetooth or Wi-Fi) via a remote computing device (e.g., see remote computing device 2824 of FIG. 28). In one embodiment, the speed v is derived from movement of pedals (not shown for clarity of illustration) of bicycle 850 by the rider, for example, by measuring a rotation rate of the pedaling. In other embodiments, simulator 800 is used with a virtual reality system, wherein the speed v is changed by controller 820 to match a movement displayed on a screen viewed by the rider while pedaling bicycle 850.

A scalar distance between where adapters 806(1) and 806(2) affix to bicycle 850 (i.e., front and rear dropouts of bicycle 850) is fixed by a geometry of bicycle 850. A longitudinal distance between rails 802(1) and 802(2) in the x direction is also fixed. In the example of FIG. 8, fork carriage 818 moves longitudinally (i.e., in the x direction) along longitudinal rail 816 to reconcile these two constraints. That is, when frame 854 has a non-zero heading angle, fork carriage 818 moves along rail 816 in the negative x direction such that front adapter 806(1) is positioned longitudinally behind front rail 802(1). In another embodiment, rear carriage 804(2) supports a longitudinal rail, similarly to longitudinal rail 816, having a carriage that supports rear adapter 806(2) and moves longitudinally to reconcile the two distance constraints when frame 854 has a non-zero heading angle. In another embodiment, both carriages 804(1) and 804(2) support a longitudinal rail such that both adapters 806(1) and 806(2) are longitudinally moveable.

In one embodiment, front adapter 806(1) includes a flexible material that bends to position front adapter 806(1) longitudinally behind front rail 802(1), wherein front adapter 806(1) connects directly to front carriage 804(1) without longitudinal rail 816 and fork carriage 818. The flexible material may be a vertically-oriented spring that bends longitudinally with the heading angle of frame 854. In another embodiment, rear adapter 806(2) includes a flexible material that bends to position rear adapter 806(2) longitudinally ahead of rear rail 802(2), thereby reconciling the two distance constraints. In another embodiment, both adapters 806(1), (2) include a flexible material to longitudinally shift respective adapters 806(1), (2).

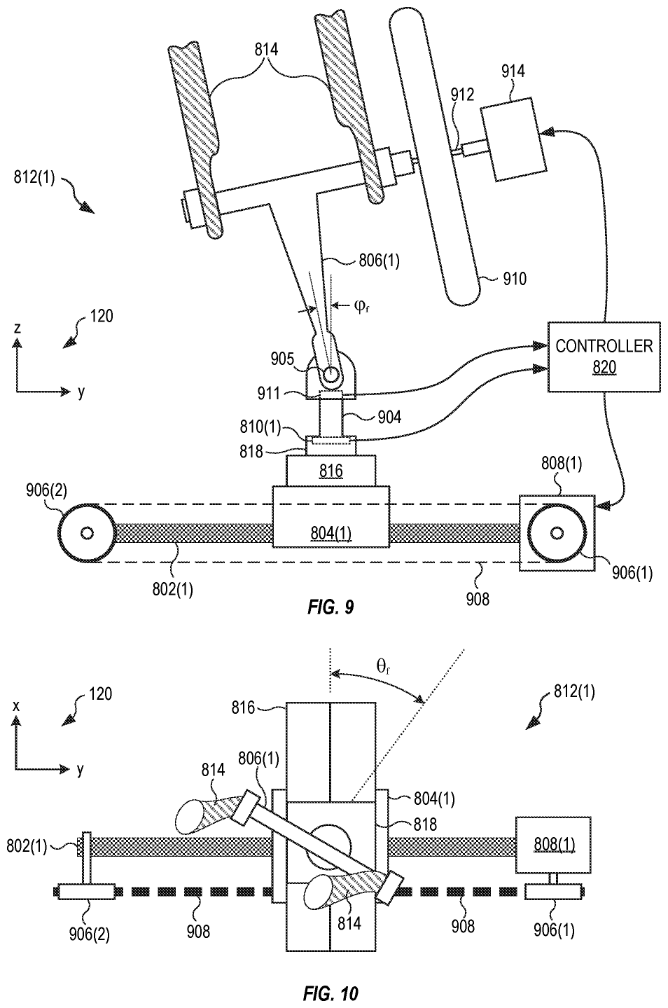

FIGS. 9 and 10 are front and top views, respectively, of front translation mechanism 812(1) of vehicle simulator 800. Actuator 808(1) rotates a pulley 906(1) at a first end of rail 802(1) to drive a belt 908 passing around a second pulley 906(2) positioned at the opposite end of rail 802(1). Carriage 804(1) is attached to belt 908 such that belt 908 moves carriage 804(1) laterally along rail 802(1) as actuator 808(1) turns pulley 906(1). Actuator 808(1) may include additional gearing that drives a shaft of pulley 906(1), as needed.

A pin 904 rotatable around a vertical rotation axis (i.e., along the z direction) protrudes from a top surface of fork carriage 818 and includes a pivot 905 that couples with adapter 806(1) and rotates around a horizontal rotation axis. Front heading sensor 810(1) couples with both fork carriage 818 and pin 904 to measure an angle of pin 904 in the x-y plane relative to the positive x direction, thereby measuring the front heading angle θ_{f} of fork 814.

Actuators 808 may be any type of linear actuator known in the art. For example, actuators 808 may be pneumatic actuators using a gas (e.g., air), hydraulic actuators using a liquid, or linear motors. In the example of FIGS. 9 and 10, each of actuator 808 is an electro-mechanical actuator that includes a motor mechanically connected to convert the rotational motion of the motor to linear motion. In one embodiment, actuators 808(1) and 808(2) drive laterally aligned wheels affixed to respective carriages 804(1) and 804(2) such that carriages 804(1) and 804(2) are controlled to move laterally over a supporting surface (e.g., the floor or ground). In another embodiment, rails 802 are each a threaded shaft rotated by the corresponding one of actuators 808, wherein each of carriages 804 includes a threaded portion, coupled to the corresponding shaft, that moves laterally as the corresponding shaft rotates.

In one embodiment, front translation mechanism 812(1) includes a front lean sensor 911 that measures a front lean angle (pf of fork 814 with respect to the z direction. That is, lean sensor 911 senses an angle by which pivot 905 rotates. Algorithm 822 of controller 820 may include additional machine-readable instructions that, when executed by the processor of controller 820, control the processor to: (i) determine a front lateral acceleration based on the front lean angle (pf received from front lean sensor 911, and (ii) control front actuator 808(1) to move front carriage 804(1) according to the front lateral acceleration. In another embodiment, rear translation mechanism 812(2) includes a rear lean sensor (not shown) that senses a rear lean angle φᵣ of frame 854 with respect to the z direction. Algorithm 822 may include additional machine-readable instructions that, when executed by the processor of controller 820, control the processor to: (i) determine a rear lateral acceleration based on the sensed rear lean angle φᵣ, and (ii) control rear actuator 808(2) to move rear carriage 804(2) according to the rear lateral acceleration.

In one embodiment, algorithm 822 includes additional machine-readable instructions that, when executed by the processor of controller 820, control front and rear actuators 808(1) and 808(2) to laterally accelerate respective carriages 804(1) and 804(2) according to the respective front and rear lean angles φ_{f}, φᵣ, to stabilize the front and rear lean angles φ_{f}, φᵣ at zero degrees. That is, algorithm 822 and controller 820 cooperate with actuators 808(1) and 808(2), carriages 804(1) and 804(2), and lean sensors (e.g., front lean sensor 911) to form two feedback loops that balance bicycle 850 without a rider, and therefore without steering. This mode of operation of simulator 800, referred to herein as “acceleration-based control”, is analogous to the balancing of inverted pendulum 102 of FIG. 1 by laterally accelerating cart 104. In other embodiments, when simulator 800 laterally translates front and rear carriages 804(1) and 804(2) at respective front and rear lateral velocities v_{y}^{(f)}, v_{y}^{(r)} determined from front and rear heading angles θ_{f}, θᵣ, simulator 800 may not fully balance bicycle 850 unless a rider is concurrently steering bicycle 850; this mode of operation of simulator 800 is referred to herein as “velocity-based control”.

In some embodiments, simulator 800 switches between acceleration-based control and velocity-based control. For example, at the beginning of a simulation, a rider may enable acceleration-based control to assist the rider with balancing bicycle 850 before the rider begins pedaling. After the rider has mounted bicycle 850 and begins pedaling, simulator 800 then switches to velocity-based control to more accurately simulate riding of bicycle 850, for example, on a road. When the rider has finished the simulation, simulator 800 then switches back to acceleration-based control, balancing bicycle 850 to assist the rider with dismounting bicycle 850. In one embodiment, the transition between acceleration-based control and velocity-based control is determined by an action of the rider, such as pedaling. For example, when the rider begins pedaling bicycle 850, controller 820 detects the pedaling (e.g., with a pedaling sensor connected to bicycle 850) and switches from acceleration-control mode to velocity-control mode in response to the pedaling. In another embodiment, controller 820 switches from velocity-control mode to acceleration-control mode when controller 820 detects that the pedaling has stopped. To prevent controller 820 from inadvertently switching to acceleration-based control while the rider is coasting, controller 820 may implement a time delay such that controller 820 switches to velocity-control mode after controller 820 has detected that the pedaling has stopped for a specified time duration (e.g., 10 seconds). In one embodiment, the rider commands controller 820 to switch between acceleration-based and velocity-based modes via a button or switch electrically coupled to controller 820. Alternatively, the rider may command controller 820 to switch between modes via a graphical user interface of a remote computing device (see remote computing device 2824 of FIG. 28) communicating wirelessly with controller 820 (e.g., via Bluetooth or Wi-Fi).

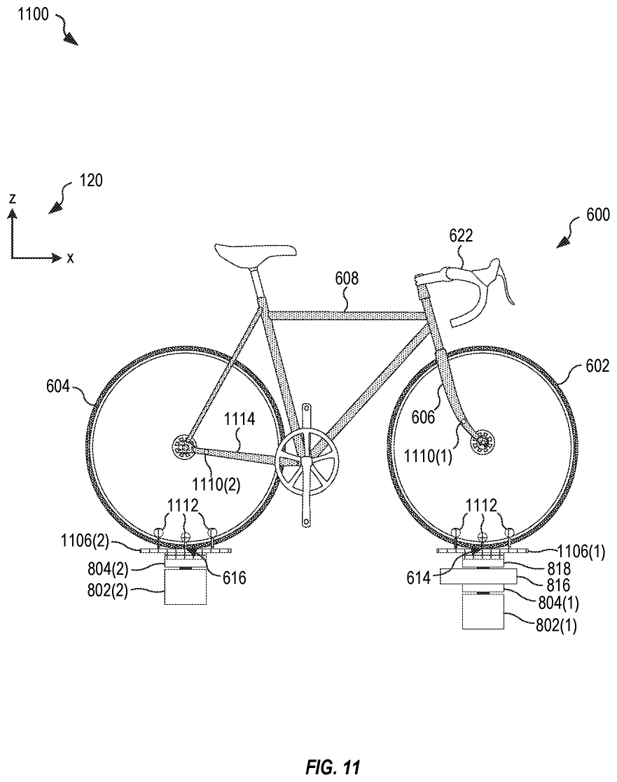

FIG. 11 is a side view showing a vehicle simulator 1100 being used with bicycle 600 of FIG. 6, that is, a bicycle including two wheels affixed thereto in the conventional manner. Simulator 1100 operates similarly to simulator 800 of FIG. 8, with front and rear adapters 1106(1), (2) replacing front and rear adapters 806(1), (2) of FIGS. 8-10. Front adapter 1106(1) is configured as a plate that supports front wheel 602 at front contact point 614. Similarly, rear adapter 1106(2) is configured as a plate that supports rear wheel 604 at rear contact point 616. Each adapter 1106 includes a plurality of wheel clamps 1112 that affix each of front and rear wheels 602, 604 to their respective adapter 1106(1), (2). Like adapters 806 of FIGS. 8-10, each adapter 1106 includes a pin rotatable about a vertical axis (e.g., pin 904) and a pivot rotatable about a horizontal axis (e.g., pivot 905) such that a heading angle and lean angle of the corresponding wheel affixed thereon may change. As each of front and rear wheels 602, 604 is affixed to an adapter 1106, front and rear wheels 602, 604 do not rotate during operation of simulator 1100. To allow a rider of bicycle 600 to pedal while rear wheel 604 is affixed to rear adapter 1106(2), a chain of bicycle 600 (not shown) may be removed from bicycle 600 such that pedaling does not apply a pedaling torque, via the chain, to rear wheel 604.

FIG. 11 shows how heading and lean sensors may be affixed directly to the vehicle (e.g., bicycle 600) as opposed to the adapters supporting the vehicle (e.g., adapters 1106). In FIG. 11, a front three-axis accelerometer 1110(1) is affixed to fork 606 of bicycle 600, and a rear three-axis accelerometer 1110(2) is affixed to a chainstay 1114 of bicycle 600. Each accelerometer 1110 communicates three mutually-orthogonal acceleration signals to controller 820. Algorithm 822 may include additional machine-readable instructions that, when executed by the processor of controller 820, control the processor to transform the three acceleration signals to determine a heading angle θ and/or a lean angle (p. Each accelerometer 1110 may include a battery and wireless transceiver to communicate the acceleration signals wirelessly with controller 820, wherein controller 820 includes a transceiver circuit to receive the wireless signals. Alternatively, each accelerometer 1110 may communicate with controller 820 via electrical wires or cables.

While FIG. 11 shows front accelerometer 1110(1) affixed to a blade of fork 606, front accelerometer 1110(1) may be alternatively affixed to an axle of front wheel 602 (e.g., a skewer), handlebars 622, a stem of bicycle 600, a steerer tube of fork 606 or any other component of bicycle 600 that moves similarly to front wheel 602 when a rider steers bicycle 600. While FIG. 11 shows rear accelerometer 1110(2) affixed to chainstay 1114, rear accelerometer 1110(2) may be alternatively affixed to a different part of frame 608 (e.g., a seat tube or seatstay), a seat of bicycle 600, an axle of rear wheel 604 (e.g., a skewer), or any other component of bicycle 600 that moves similarly to rear wheel 604 when a heading of rear wheel 604 changes. In one embodiment, front and rear accelerometers 1110(1), (2) are affixed to respective adapters 1106(1), (2) instead of bicycle 600.

While the example of FIG. 11 shows simulator 1100 with accelerometers 1110 for sensing heading and lean angles, simulator 1100 may instead employ a different type of rotation sensor. For example, each heading sensor (e.g., front and rear heading sensors 810(1), (2)) and lean sensor (e.g., front lean sensor 911) may be a rotary encoder or gyroscope. When heading and lean angles are sensed with separate sensors (e.g., front heading sensor 810(1) and front lean sensor 911), the separate sensors may be mounted to bicycle 600 similarly to accelerometers 1110.

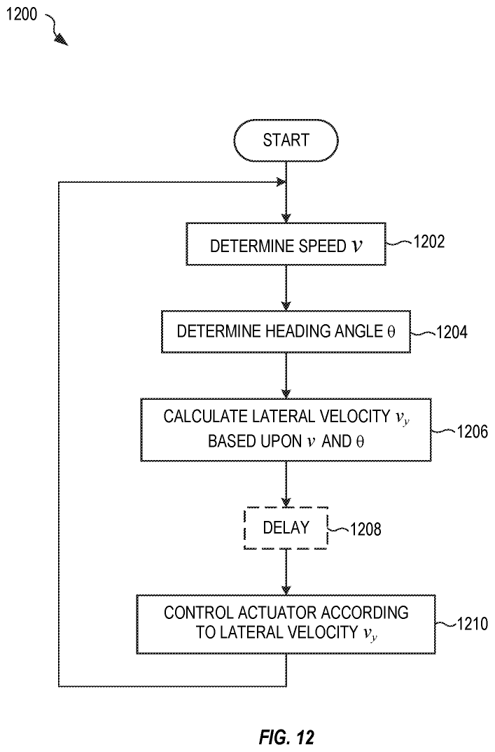

FIG. 12 is a flow chart illustrating a method 1200 for controlling lateral movement of a carriage via an actuator (e.g. front actuator 808(1) of FIG. 8). Method 1200 may be implemented as algorithm 822 of controller 820. Method 1200 includes a step 1202 to determine a speed v. In one example of step 1202, the speed v is predefined as 10 miles per hour. In another example of step 1202, the speed v is measured from motion of pedals of bicycle 850. Method 1200 also includes a step 1204 to determine a heading angle θ. In one example of step 1204, controller 820 measures the front heading angle θ_{f} using front heading sensor 810(1) of FIGS. 8 and 9. Method 1200 also includes a step 1206 to calculate the lateral velocity v_{y} based on the speed v and the heading angle θ determined by steps 1202 and 1204, respectively. Method 1200 also includes a step 1210 to control the actuator to laterally move a corresponding carriage according to the lateral velocity v_{y}. In one example of step 1210, controller 820 controls front actuator 808(1) to move carriage 804(1) at the front lateral velocity v_{y}.

In one embodiment, method 1200 includes a delay step 1208 to wait for a predefined period. In one example of step 1208, controller 820 waits for 100 milliseconds. In another embodiment, method 1200 repeats steps 1202 through 1210 to periodically control the actuator to laterally move the carriage based on a changing speed v and/or heading angle θ. For example, as a rider changes the heading angle θ, method 1200 may periodically determine the heading angle θ, update the lateral velocity v_{y} according to the determined heading angle θ, and control the actuator according to the updated lateral velocity v_{y}.

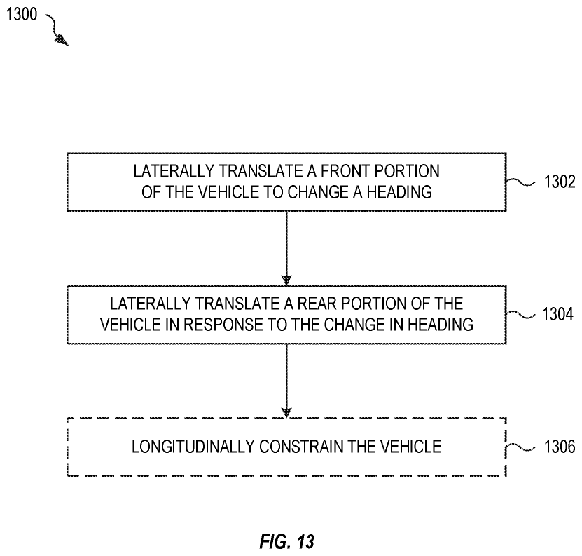

FIG. 13 is a flow chart illustrating a method 1300 to assist balancing of a human-supported vehicle. Method 1300 includes a step 1302 to laterally translate a front portion of the vehicle to change a heading of a rear portion of the vehicle in response to steering of the vehicle. As an example of step 1302, controller 820 determines a front heading angle θ_{f} from front rotation sensor 810(1), and controls front actuator 808(1) to laterally move front carriage 804(1) according to the sensed front heading angle θ_{f}. Method 1300 also includes a step 1304 to laterally translate a rear portion of the vehicle in response to the change in heading. As an example of step 1304, controller 820 determines a rear heading angle θᵣ from rear heading sensor 810(2), and controls rear actuator 808(2) to laterally move rear carriage 804(2) along rail 802(2) according to the sensed rear heading angle θᵣ. In one embodiment, method 1300 includes a step 1306 to longitudinally constrain the vehicle. As an example of step 1306, rails 802 of FIG. 8 are oriented laterally such that carriages 804 may only move laterally.

Although simulator 800 assists with balancing bicycle 850, the ease of balancing bicycle 850 is reduced as compared to balancing a bicycle with wheels rolling on a flat surface (e.g., bicycle 600 of FIGS. 6 and 7). That is, bicycle 850 may be harder to balance than bicycle 600, when rolling on a surface, because simulator 800 does not include gyroscopic effects of a spinning mass (e.g., front wheel 602) on front fork 814. A spinning front wheel generates a torque that resists steering. By contrast, a scooter has wheels with much smaller rotational inertia than bicycle wheels, and thus a scooter does not require as much steering torque to overcome gyroscopic effects. A scooter, and other vehicles having wheels with little rotational inertia, are therefore well-suited for simulator 800.

In one embodiment, simulator 800, when used with bicycle 850, includes a spinning mass 910 that produces a torque to replicate the torque produced by a spinning bicycle wheel when the bicycle wheel is affixed to front fork 814 in the conventional manner. In the example of FIG. 9, spinning mass 910 rotates around an axle 912 that connects to one side of adapter 806(1). A motor 914, controllable by controller 820, connects to the axle to rotate spinning mass 910.

Spinning mass 910 may have any diameter, width, weight, and shape to replicate the torque produced by a spinning bicycle wheel. In the example of FIG. 9, spinning mass 910 has a diameter smaller than that of a bicycle wheel so as to not to interfere with any component proximate to spinning mass 910 (e.g., actuator 808(1), rail 802(1), belt 908). In this case, spinning mass 910 may have a smaller rotational inertia than a bicycle wheel sized to couple with front fork 814. To replicate the torque generated by the bicycle wheel, a mass of spinning mass 910 may be increased, for example, by forming spinning mass 910 from a material with a higher density than the bicycle wheel, or increasing a thickness of spinning mass 910. Alternatively, spinning mass 910 may be rotated by motor 914 at a rotation rate high enough to compensate for the smaller rotational inertia of spinning mass 910.

While FIG. 9 shows spinning mass 910 affixed, via axle 912, to one side of adapter 806(1), spinning mass 910 may be similarly affixed to the opposite side of adapter 806(1) in a similar manner. Alternatively, spinning mass 910 may be connected, via axle 912, directly to front fork 814. As shown in FIG. 9, the location of spinning mass 910 on one side of front fork 814 will generate a clockwise lean torque that rotates front fork 814 about pivot 905 to change the lean angle φ_{f}. To balance this lean torque, a second spinning mass similar to spinning mass 910 may be affixed to the opposite side of adapter 806(1). Similar to spinning mass 910, this second spinning mass may be driven by a second motor controllable by controller 820.

In another embodiment, simulator 1100, when used with bicycle 600, includes at least one spinning mass, similar to spinning mass 910, that produces a torque to replicate the torque produced by front wheel 602 when front wheel 602 is spinning. The examples, configurations, and usage of spinning mass 910 described above for FIG. 9 may also apply to simulator 1100, when used with bicycle 600.

As appreciated, actuators 808 may be controlled to simulate various levels of stability and control, far beyond those available on a real bicycle. In one embodiment, algorithm 822 controls actuators 808 to simulate a bicycle with front and/or rear wheel steering.

Embodiments with Moving Surfaces

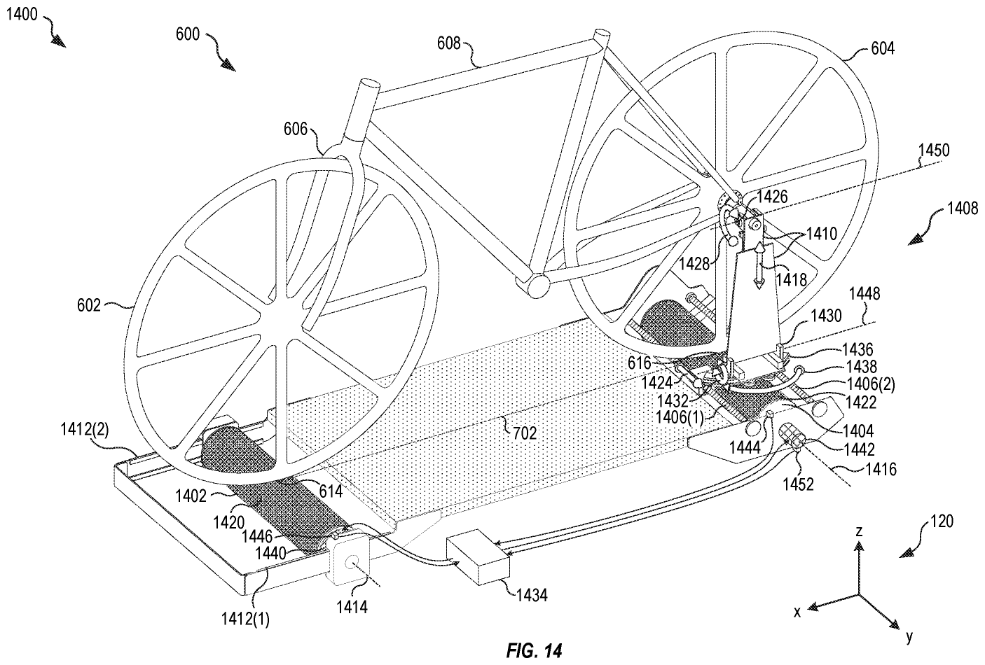

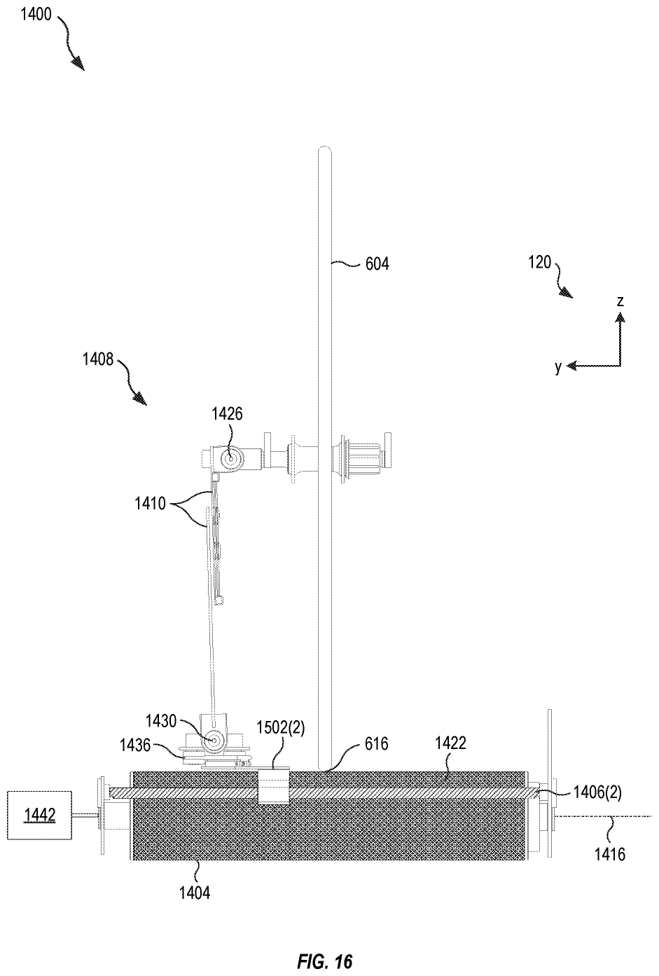

FIGS. 14, 15, and 16 are perspective, top, and rear views, respectively, of a vehicle simulator 1400 that advantageously replicates riding of bicycle 600 on a road by supporting each of front and rear wheels 602, 604 of bicycle 600 at a single contact point. Simulator 1400 laterally moves bicycle 600, in response to steering, without sensing heading angles of front and wheels 602, 604. Thus, simulator 1400 may advantageously operate without heading angle sensors.

Simulator 1400 includes a front roller 1402 with a front surface 1420 that supports front wheel 602 of bicycle 600 at front contact point 614. Front roller 1402 rotates about a laterally-oriented front rotation axis 1414 to move front surface 1420 longitudinally at front contact point 614, thereby rotating front wheel 602. When rotating, front wheel 602 laterally translates along moving front surface 1420 in response to steering of bicycle 600. That is, as bicycle 600 is steered (i.e., the front heading angle θ_{f} of front wheel 602 is changed), front wheel 602 laterally accelerates to translate laterally along moving front surface 1420.

Simulator 1400 also includes a rear drum 1404 with a rear surface 1422 that supports rear wheel 604 of bicycle 600 at rear contact point 616. Rear drum 1404 is rotatable about a laterally-oriented rear rotation axis 1416 parallel to front rotation axis 1414. When rear wheel 604 is rotated by pedaling, rear wheel 604 longitudinally moves rear surface 1422 at rear contact point 616 by applying a torque to rear surface 1422 at rear contact point 614 that rotates rear drum 1404 around rear rotation axis 1416.

Lateral motion of front wheel 602 moves fork 606 likewise, changing a heading of frame 608 by rotating rear wheel 604 around a vertical support axis that coincides with rear support point 616 (see rear support axis 612 in FIG. 6). Rear wheel 604, when rotating around its axle (e.g., by pedaling), laterally translates along moving rear surface 1422 in response to the change of its heading. That is, rear wheel 604 laterally accelerates to translate laterally along rear surface 1422.

In FIG. 14, bicycle 600 is positioned such that rear contact point 616 coincides with a ground contact point of rear wheel 604. That is, rear drum 1404 supports rear wheel 604 where a flat road would support rear wheel 604 if bicycle 600 were being used on the flat road. Simulator 1400 includes an adjustable spacer that allows front roller 1402 to be longitudinally positioned such that front roller 1402 supports a ground contact point of front wheel 602. With the adjustable spacer, simulator 1400 can accommodate different sizes and types of bicycle 600. In FIG. 14, the adjustable spacer is shown as first and second rails 1412(1) and 1412(2), wherein front roller 1402 is longitudinally positioned along first and second rails 1412(1) and 1412(2) such that front contact point 614 coincides with the ground contact point of front wheel 602, i.e., front roller 1402 supports front wheel 602 where the flat road would support front wheel 602 if bicycle 600 were being used on the road.

Simulator 1400 also includes a longitudinal restraint mechanism 1408 that longitudinally restrains bicycle 600 such that front wheel 602 remains in contact with front surface 1420, and rear wheel 604 remains in contact with rear surface 1422. Longitudinal restraint mechanism 1408 prevents bicycle 600 from moving longitudinally off of front roller 1402 and rear drum 1404.

Longitudinal restraint mechanism 1408 includes an arm 1410 having a length extendable along a direction 1418. When bicycle 600 is upright (i.e., rear wheel 604 has a zero lean angle, as shown in FIGS. 14-16), direction 1418 is approximately parallel to the z direction. At a top end of arm 1410, a top joint 1426, rotatable in a direction 1428 around a top rotation axis 1450 parallel to lean axis 702, affixes to bicycle 600. While FIGS. 14-16 show top joint 1426 coupling with an axle of rear wheel 604, top joint 1426 may alternatively couple with frame 608. At a bottom end of arm 1410, a bottom joint 1430, rotatable in a direction 1432 around a bottom axis 1448 parallel to lean axis 702, supports arm 1410. When rear wheel 604 has a zero heading angle, the top and bottom rotation axes 1448 and 1450 are parallel to the x axis.

Longitudinal restraint mechanism 1408 also includes a turntable 1436 that supports bottom joint 1430. Turntable 1436 is rotatable in a direction 1438 about a vertical turntable axis parallel to the z direction. In one embodiment, the vertical turntable axis coincides with rear contact point 616 such that the turntable axis and the rear support axis (e.g., rear support axis 612 of FIG. 6) coincide. In this embodiment, arm 1410 rotates about the turntable axis to follow rear wheel 604 when rear heading angle θ, changes.

Longitudinal restraint mechanism 1408 also includes first and second carriages 1502(1) and 1502(2) that support turntable 1436 and are moveable along first and second linear guide rails 1406(1) and 1406(2), respectively. Thus, as rear wheel 604 laterally translates along rear surface 1422, longitudinal restraint mechanism 1408 laterally translates along guide rails 1406 likewise (see direction 1424). While the example of FIGS. 14-16 shows guide rails 1406(1) and 1406(2) as cylindrical rods extending along the y direction and having a circular cross section, guide rails 1406(1) and 1406(2) may alternatively have a different shape (e.g., rectangular or square cross section).

When bicycle 600 is steered by a rider, turntable 1436 rotates in direction 1438 such that bottom rotation axis 1448 of bottom joint 1430 remains parallel to lean axis 702. Furthermore, top joint 1426 rotates along direction 1428, bottom joint 1430 rotates along direction 1432, and arm 1410 changes length along direction 1418, such that arm 1410 rotates about bottom rotation axis 1448. Thus, arm 1410 follows the motion and orientation of rear wheel 604 while preventing bicycle 600 from moving longitudinally (i.e., in the x direction).

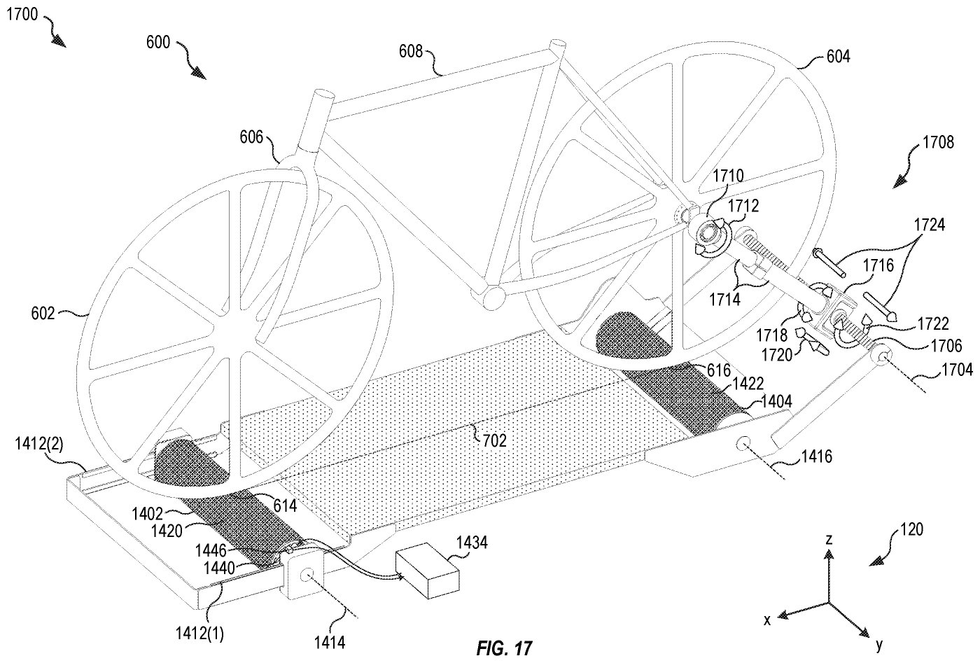

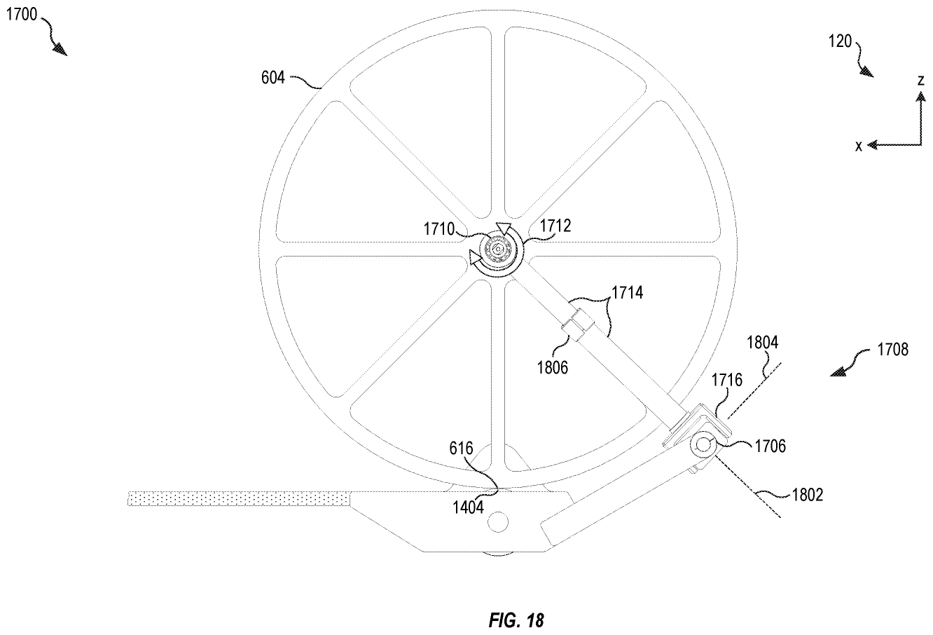

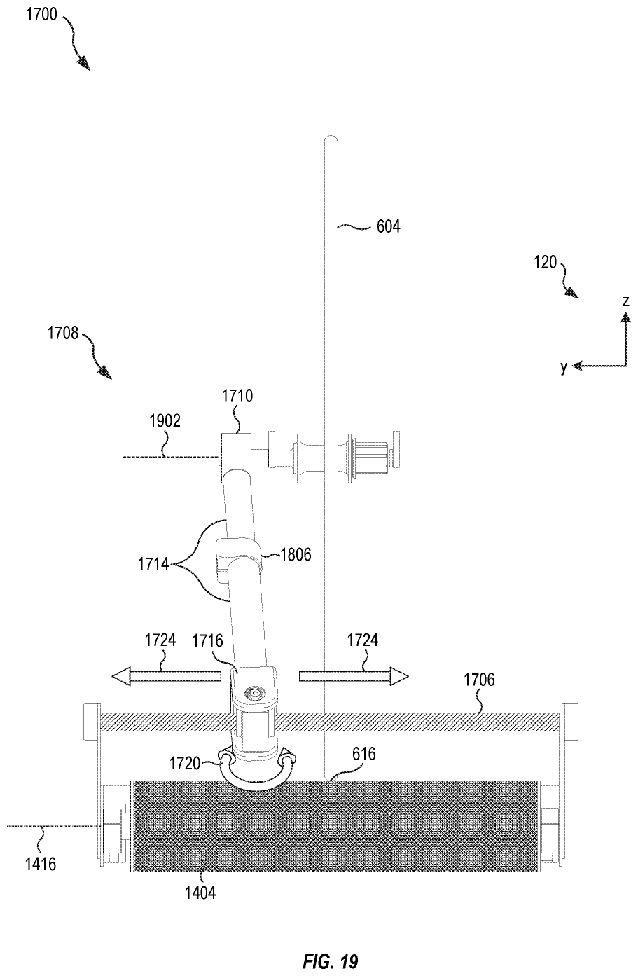

FIGS. 17, 18, and 19 are perspective, side, and rear views, respectively, of another vehicle simulator 1700 that advantageously replicates riding bicycle 600 on a road by supporting each of front and rear wheels 602, 604 of bicycle 600 at a single contact point. Simulator 1700 is similar to simulator 1400, except that a longitudinal restraint mechanism 1708 replaces longitudinal restraint mechanism 1408, and a linear guide 1706 replaces first and second linear guide rails 1406(1) and 1406(2).

Longitudinal restraint mechanism 1708 includes an arm 1714 with a first end having a joint 1716 that couples to linear guide 1706. Linear guide 1706 is a cylindrical bar with a guide axis 1704 oriented parallel to front and rear rotation axes 1414, 1416 such that joint 1716 is laterally moveable along linear guide 1706 in direction 1724 (e.g., the y direction). Joint 1716 allows arm 1714 to (i) rotate in a direction 1722 around guide axis 1704, (ii) twist in a direction 1718 around a longitudinal axis 1802 of arm 1714, and (iii) pivot in a direction 1720 around a pivot axis 1804 lying in the x-z plane. Pivot axis 1804 is perpendicular to longitudinal axis 1802 and guide axis 1704. When bicycle 600 does not lean and rear wheel 604 has a zero heading angle θᵣ, longitudinal axis 1802 and guide axis 1704 are perpendicular. When bicycle 600 leans and/or rear wheel 604 has a non-zero heading angle θᵣ, longitudinal axis 1802 and guide axis 1704 may be not perpendicular.

A second end of arm 1714 has a rolling-element bearing 1710 that connects to bicycle 600 such that arm 1714 is rotatable in a direction 1712 about a rotation axis 1902 of rear wheel 604. In FIGS. 17-19, where rear wheel 604 is shown with a zero heading angle and a zero lean angle, rotation axis 1902 is parallel to the y direction. While FIGS. 17-19 show rolling-element bearing 1710 coupling with an axle of rear wheel 604, rolling-element bearing 1710 may alternatively couple with frame 608.

When bicycle 600 is steered by a rider in response to leaning, arm 1714: (i) laterally translates along linear guide 1706, (ii) twists around longitudinal axis 1802, (iii) rotates around rotation axis 1902 of rear wheel 604, (iv) rotates around guide axis 1704, and (v) pivots around pivot axis 1804, such that arm 1714 remains approximately parallel to a rotation plane of rear wheel 604. Thus, arm 1714 follows the motion and orientation of rear wheel 604 while preventing bicycle 600 from moving longitudinally (i.e., in the x direction).

A length of arm 1714 remains fixed during operation of simulator 1700. To accommodate different sizes of bicycle 600 and rear wheel 604, the length of arm 1714 may be adjusted. As shown in FIGS. 17-19, arm 1714 is a telescopic arm whose length may be adjusted by loosening an arm clamp 1806. After arm 1714 has been extended to a desired position, arm clamp 1806 may be retightened to fix the length of arm 1714.

In FIGS. 14-19, front surface 1420 of simulators 1400 and 1700 is the cylindrical surface of front roller 1402. In some embodiments, front surface 1420 is formed from a driven belt, such as that used with a treadmill. The driven belt may be positioned in contact with front wheel 602 such that, when moving longitudinally, the belt rotates front wheel 602. In other embodiments, rear surface 1422 is formed from a belt positioned in contact with rear wheel 604 such that rear wheel 604, when rotated (e.g., by pedaling), longitudinally moves the belt.

In FIGS. 14-19, longitudinal restraint mechanisms 1408 and 1708 constrain rear contact point 616 to coincide with a top of rear drum 1404 (i.e., the lateral line directly above rear rotation axis 1416) regardless of the lateral position, rear heading angle, and rear lean angle of rear wheel 604. A wheelbase wb of bicycle 600, equal to the scalar distance between front and rear contact points 614, 616, is fixed by a geometry of bicycle 600. Similarly, the perpendicular distance between front and rear rotation axes 1414, 1416 is also fixed. Thus, when a heading of rear wheel 604 is non-zero, front contact point 614 may not remain on a top of front roller 1402 (i.e., the lateral line directly above front rotation axis 1414). That is, front contact point 614 may occur longitudinally behind the top of front roller 1402. However, a diameter of front roller 1402 may be chosen to be large enough such that the change in longitudinal position of front contact point 614 has no impact on operation of the vehicle simulator. For example, when bicycle 600 has a wheelbase wb of 100 cm, front roller 1402 may be positioned, via rails 1412, such that front rotation axis 1414 is 100 cm from rear rotation axis 1416. For small heading angles (e.g., less than) 10°, the change in longitudinal position of front contact point 614 may be approximated by wb×θᵣ²/2, where θᵣ is the rear heading angle in radians. When rear wheel 604 has a heading angle of 5°, front contact point 614 will be located 3.8 mm behind the top of front roller 1402. Thus, the diameter of front roller 1402 may be chosen to be larger than this value (e.g., 10 cm) such that the curvature of front surface 1420 may be ignored.

Front surface 1420, whether implemented as a roller or belt, may be longitudinally moved by a motor 1440 controlled by a controller 1434. In the examples of FIGS. 14 and 17, motor 1440 is positioned inside front roller 1402 such that a shaft of motor 1440 coincides with front rotation axis 1414, front surface 1420 rotating around motor 1440. Motor 1440 may also be placed outside of front roller 1402 (e.g., see location of electric motor 1442 relative to rear drum 1404).

Controller 1434 includes a processor, memory, and interface hardware that controls motor 1440. Controller 1434 may store a value for the speed v. In one embodiment, a user (e.g., a rider of bicycle 600) enters a value of the speed v to controller 1434, where it is stored in the memory and used to control motor 1440 such that front surface 1420 moves longitudinally according to the speed v. The user may enter the speed v to controller 1434 via a graphical user interface of controller 1434, or wirelessly (e.g., Bluetooth or Wi-Fi) via a remote computing device (e.g., see remote computing device 2824 of FIG. 28). In some embodiments, a front rotation sensor 1446 senses a rotation rate of front roller 1402; controller 1434 may control motor 1440 to rotate at a rate such that the rotation rate sensed by front rotation sensor 1446 follows a rotation rate setpoint. That is, controller 1434 may use a feedback loop to stabilize the rotation rate of front roller 1402 to the rotation rate setpoint.

In some embodiments, controller 1434 controls motor 1440 to rotate front roller 1402 such that front surface 1420 moves faster than the speed v when a rider of bicycle 600 begins pedaling, advantageously assisting the rider in balancing bicycle 600 without the use of side rails and/or balance rails. In one such embodiment, where front and rear surfaces 1420, 1422 start at rest, the rider signals to controller 1434 to begin operation of simulator 1400, at which time motor 1440 angularly accelerates front roller 1402. After controller 1434 has detected, via front rotation sensor 1446, that the speed of front surface 1420 has reached the speed v, controller 1434 stops accelerating front roller 1402 to maintain front surface 1420 moving at the speed v. Controller 1434 then indicates to the rider (e.g., audibly with a tone, or visibly with a light) that front surface 1420 has reached the speed v. After receiving the indication, the rider may then begin pedaling bicycle 600 to move rear surface 1422, thereby angularly accelerating rear drum 1404. Thus, the rider begins balancing of bicycle 600 with front wheel 602 already rotating, assisting the rider with steering bicycle 600 while the rider subsequently rotates rear wheel 604 to accelerate rear surface 1422 up to the speed v.

In the above example, motor 1440 accelerates front surface 1420 to the speed v. In other embodiments, motor 1440 accelerates front surface 1420 to a speed greater than v. A rear rotation sensor 1444 may be connected to sense a rotation rate of rear drum 1404; when controller 1434 determines, via rear rotation sensor 1444, that the speed of rear surface 1422 has reached v, controller 1434 may then control motor 1440 to decelerate front surface 1420. When controller 1434 determines that the speed of front surface 1420 has slowed to v, controller 1434 then stops decelerating front roller 1402 to maintain front surface 1420 moving at speed v.

In another embodiment, a drive belt 1504 connects rear drum 1404 with front roller 1402 such that rear drum 1404 rotates front roller 1402 instead of motor 1440. When rear drum 1404 and front roller 1402 have the same diameter, drive belt 1504 rotates front roller 1402 at the same rotation rate as rear drum 1404, thereby ensuring that front and rear surfaces 1420, 1422 move at the same longitudinal speed (i.e., front surface 1420 moves at a longitudinal speed similar to a longitudinal speed of rear surface 1422).

In some embodiments, a resistance generator is used to resist longitudinal motion of rear surface 1422, thereby replicating drag, wind resistance, rolling resistance, and other effects acting on bicycle 600, and/or a rider thereon, when bicycle 600 is ridden outside on a road. In the example of FIGS. 14-16, the resistance generator is an electric motor 1442 physically coupled with rear drum 1404 and controllable by controller 1434 in a motoring mode and a generator mode. When a rider of bicycle 600 is pedaling to rotate rear drum 1404, electric motor 1442 may be driven to produce a torque opposing the rotation of rear drum 1404. A torque sensor 1452 outputting a torque signal may be used with electric motor 1442 such that controller 1434 can monitor the torque applied by electric motor 1442 to rear drum 1404. Controller 1434 may be configured to compare the torque signal to a torque setpoint, and control electric motor 1442 such that the torque signal follows the torque setpoint. That is, controller 1434 may cooperate with electric motor 1442 and torque sensor 1542 to form a feedback loop that stabilizes the torque signal to the torque setpoint.

In another embodiment, electric motor 1442 rotates rear drum 1404 to rotate rear wheel 604 to assist the rider with balancing bicycle 600 while mounting and/or dismounting bicycle 600. For example, at the beginning of a simulation, controller 1434 may operate electric motor 1442 in motoring mode to rotate rear drum 1404 such that the rider mounts bicycle 600 with rear wheel 604 already rotating. After the rider begins pedaling, controller 1434 operates electric motor 1442 in the generator mode to apply a torque to rear drum 1404 that simulates a resistance force when riding bicycle 600 outside on a road. Controller 1434 may detect the pedaling (e.g., with a pedaling sensor connected to bicycle 600) to switch from the motoring mode to the generator mode in response to the pedaling.

Although not shown in FIGS. 17-19, vehicle simulator 1700 may also be operated with electric motor 1442, front rotation sensor 1446, rear rotation sensor 1444, and torque sensor 1452 in a manner similar to that shown in FIGS. 14-16. Furthermore, electric motor 1442 may be located inside rear drum 1404, similar to the location of motor 1440 inside front roller 1402. When electric motor 1442 is located inside rear drum 1404, rear surface 1422 rotates around electric motor 1442.

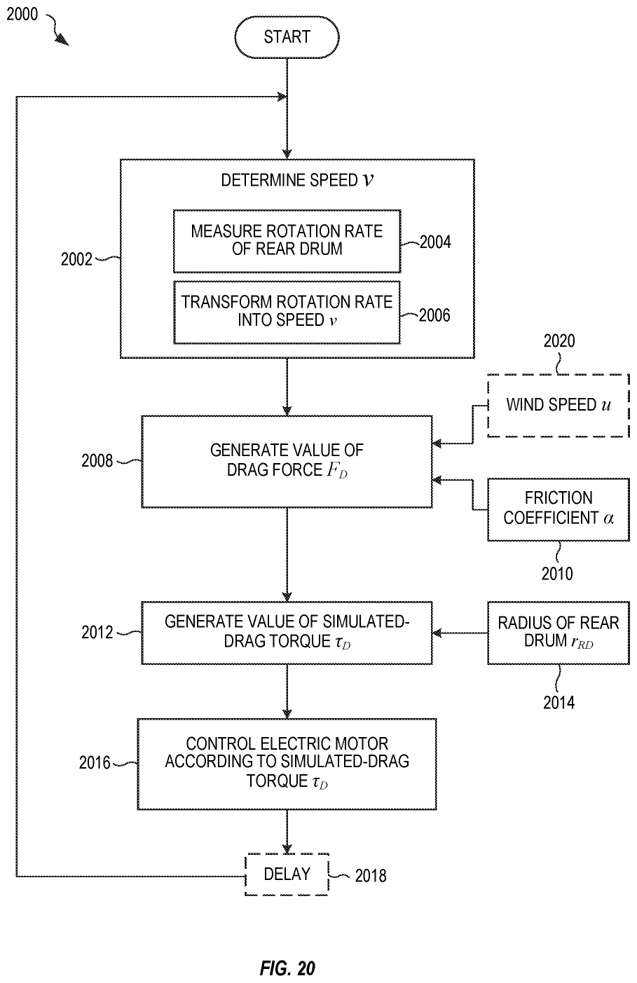

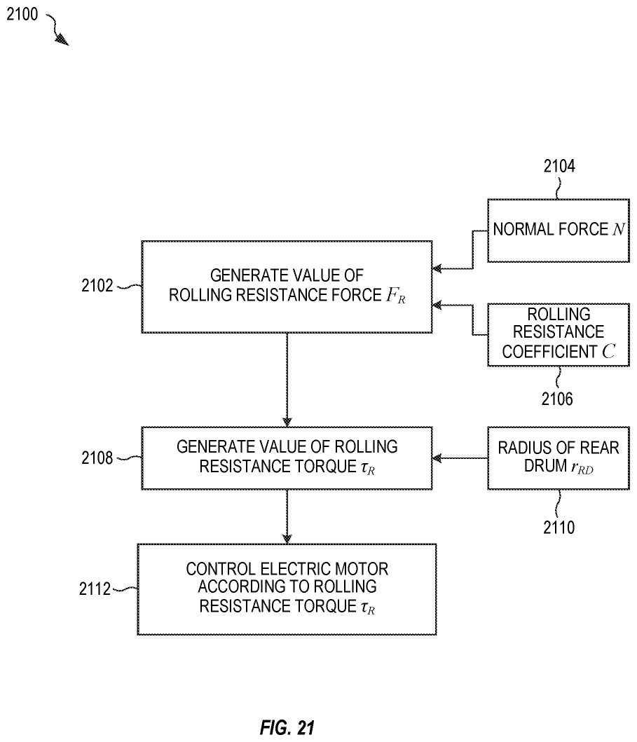

FIG. 20 is a flow chart illustrating a method 2000 for controlling a resistance generator (e.g., electric motor 1442) to simulate drag. One model of drag represents a drag force F_{D} by F_{D}=α v², where v is the speed of bicycle 600 and α is a friction coefficient that depends on the cross-sectional area of bicycle 600 and the rider mounted thereon. Method 2000 includes a step 2002 to determine the speed v. In one embodiment, method 2000 includes a step 2004 to measure the rotation rate of rear drum 1404, and a step 2006 to transform the measured rotation rate into the (linear) speed v. In one example of step 2004, controller 1434 measures the rotation rate of rear drum 1404 via rear rotation sensor 1444. In another example of step 2004, controller 1434 senses a voltage across electrical terminals of electric motor 1442. In one example of step 2006, controller 1434 multiplies the measured rotation rate of rear drum 1404 by a radius r_{RD} of rear drum 1404, as stored in the memory of controller 1434.

Method 2000 also includes a step 2008 to generate a value of the drag force F_{D} from the speed v. In one example of step 2008, controller 1434 implements the model of drag by (i) squaring the value of the speed v, and (ii) multiplying the squared speed by a value of α. Method 2000 includes a step 2010 to provide a value of α. As one example of step 2010, controller 1434 accesses a value of α stored in the memory of controller 1434.

Method 2000 also includes a step 2012 to generate a value of simulated-drag torque τ_{D} from the drag force F_{D}. In one example of step 2012, controller 1434 multiplies the value of drag force F_{D} by the value of the radius r_{RD} of rear drum 1404. Method 2000 includes a step 2014 to provide the value of r_{RD}. As one example of step 2014, controller 1434 accesses the value of r_{RD} stored in the memory of controller 1434.

Method 2000 also includes a step 2016 to control electric motor 1442 according to the value of the simulated-drag torque τ_{D}. In one example of step 2016, the processor of controller 1434 controls a digital-to-analog converter of controller 1434 that feeds a motor drive circuit (e.g., a pulse-width modulation (PWM) circuit) of controller 1434, the output of the motor drive circuit being electrically connected to electric motor 1442.

In one embodiment, method 2000 repeats steps 2002 through 2016 to periodically update the simulated-drag torque τ_{D} according to a changing speed v. In another embodiment, method 2000 includes a delay step 2018 to wait before repeating steps 2002 through 2016. In one example of step 2018, controller 1434 waits for 100 milliseconds. In other embodiments, step 2008 generates a value of drag force F_{D} according to a model of drag that includes higher-order velocity terms (e.g., v³, v⁴, etc.), wherein the memory of controller 1434 stores additional coefficients for implementing the model. The user/rider may communicate the values of the friction coefficient α and/or the radius r_{RD} of rear drum 1404 to controller 1434 via a graphical user interface of controller 1434, front panel controls of controller 1434, or a remote computing device wirelessly coupled with controller 1434 (e.g., see remote computing device 2824 of FIG. 28).

In another embodiment, method 2000 includes controlling electric motor 1442 to simulate a headwind and/or tailwind. For example, a value for a longitudinal wind speed u may be stored in the memory of controller 1434, a positive value of u corresponding to a tailwind and a negative value of u corresponding to headwind. One model of drag that accounts for a headwind and tailwind represents the drag force F_{D} by F_{D}=α(v−u)². In one example of step 2008, controller 1434 implements this model by (i) adding the wind speed u to the measured speed v to generate a relative speed, (ii) squaring the relative speed, and (iii) multiplying the squared relative speed by the value of α. In this embodiment, method 2000 includes a step 2020 to provide the value of the wind speed u. As one example of step 2020, controller 1434 accesses a value of u stored in the memory of controller 1434.

FIG. 21 is a flow chart illustrating a method 2100 for controlling a resistance generator (e.g., electric motor 1442) to simulate rolling resistance of bicycle 600 riding on a road. One model of rolling resistance represents a rolling resistance force F_{R} by F_{R}=C N, where C is a dimensionless rolling resistance coefficient and N is a normal force exerted by rear surface 1422 on rear wheel 604. The normal force N depends on a load applied to rear wheel 604, i.e., a weight of bicycle 600 and the rider. The user/rider may communicate values of the coefficient C and/or normal force N to controller 1434 in a manner similar to those described above.

Method 2100 includes a step 2102 to generate a value of the rolling resistance force F_{R}. In one example of step 2102, controller 1434 implements the rolling resistance model by multiplying the values of coefficient C and normal force N to generate a value of the rolling resistance force F_{R}. Method 2100 also includes a step 2104 to provide a value of N, and a step 2106 to provide a value of coefficient C. As one example of step 2104, controller 1434 accesses a value of N stored in the memory of controller 1434. As one example of step 2106, controller 1434 accesses a value of C stored in the memory of controller 1434.

Method 2100 includes a step 2108 to generate a value of rolling resistance torque τ_{R} from the rolling resistance force F_{R}. In one example of step 2108, controller 1434 multiplies the value of rolling resistance force F_{R} by the value of the radius r_{RD} of rear drum 1404. Method 2100 also includes a step 2110 to provide the value of r_{RD}. As one example of step 2110, controller 1434 accesses the value of r_{RD} stored in the memory of controller 1434.

Method 2100 includes a step 2112 to control electric motor 1442 according to the value of the rolling resistance torque τ_{R}. In one example of step 2112, the processor of controller 1434 controls a digital-to-analog converter of controller 1434 that feeds a motor drive circuit (e.g., a PWM circuit) of controller 1434, the output of the motor drive circuit being electrically connected to electric motor 1442.

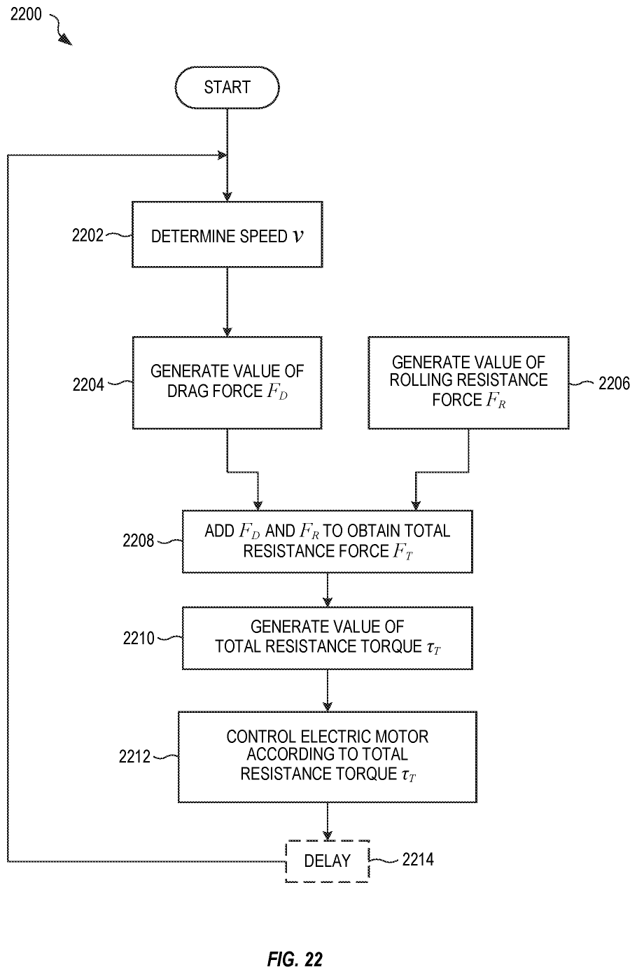

FIG. 22 is a flow chart illustrating a method 2200 for controlling a resistance generator (e.g., electric motor 1442) to simulate more than one resistance force simultaneously. Specifically, method 2200 simulates a drag force F_{D} and a rolling resistance force F_{R}. Method 2200 includes a step 2202 that determines the speed v of bicycle 600, and a step 2204 that generates a value of drag force F_{D} from the speed v. Step 2002 of method 2000 is one example of step 2202, and step 2008 of method 2000 is one example of step 2204. Method 2200 also includes a step 2206 that generates a value of rolling resistance force F_{R}. Step 2102 of method 2100 is one example of step 2206.

Method 2200 includes a step 2208 that adds the drag force F_{D} and rolling resistance force F_{R} to generate a total resistance force F_{T}. In one example of step 2208, the processor of controller 1434 adds a value of resistance force F_{R} stored in the memory of controller 1434 and a value of the drag force F_{D} stored in the memory of controller 1434. The processor may then store the resulting value of total resistance force F_{T} in the memory of controller 1434.

Method 2200 includes a step 2210 to generate a total resistance torque τ_{T} from the total resistance force F_{T}. In one example of step 2210, controller 1434 multiplies the total resistance force F_{T} by the value of the radius r_{RD} of rear drum 1404. Step 2012 of method 2000 and step 2108 of method 2100 are examples of step 2210. Method 2200 also includes a step 2212 to control electric motor 1442 according to the total resistance torque τ_{T}. Step 2016 of method 2000 and step 2112 of method 2100 are examples of step 2212.

In one embodiment, method 2200 repeats steps 2202 through 2212 to periodically update the drag force F_{D} according to a changing speed v. When rolling resistance force F_{R} depends neither on the speed v nor any other quantity that changes with time, rolling resistance force F_{R} need not be recalculated with each iteration of method 2200. For example, a value for rolling resistance force F_{R} may be calculated once and stored in the memory of controller 1434; step 2206 may then access the value of rolling resistance force F_{R} from the memory of controller 1434 with each iteration of method 2200. Method 2200 may also include a delay step 2214 to wait before repeating steps 2202 through 2212. In one example of step 2214, controller 1434 waits for 100 milliseconds between iterations of method 2200.

Models of drag, headwind/tailwind, and rolling resistance presented above are representative of the types of physical forces that may act on bicycle 600, and the rider thereon, when bicycle 600 is ridden outside on a road. These models are not intended to be limiting, and models of other physical phenomena may be similarly simulated without departing from the scope hereof. For example, the resistance generator may be used to simulate forces due to cross-winds and/or riding bicycle 600 at an incline. In certain embodiments, when simulating physical forces that would accelerate bicycle 600 (e.g., a tailwind, or riding downhill), controller 1434 may at times operate electric motor 1442 in motoring mode to accelerate rear surface 1422 accordingly. While method 2200 is shown simultaneously simulating a drag force F_{D} and a rolling resistance force F_{R}, method 2200 may simulate any number and/or types of resistance forces, wherein step 2208 sums the resistance forces.

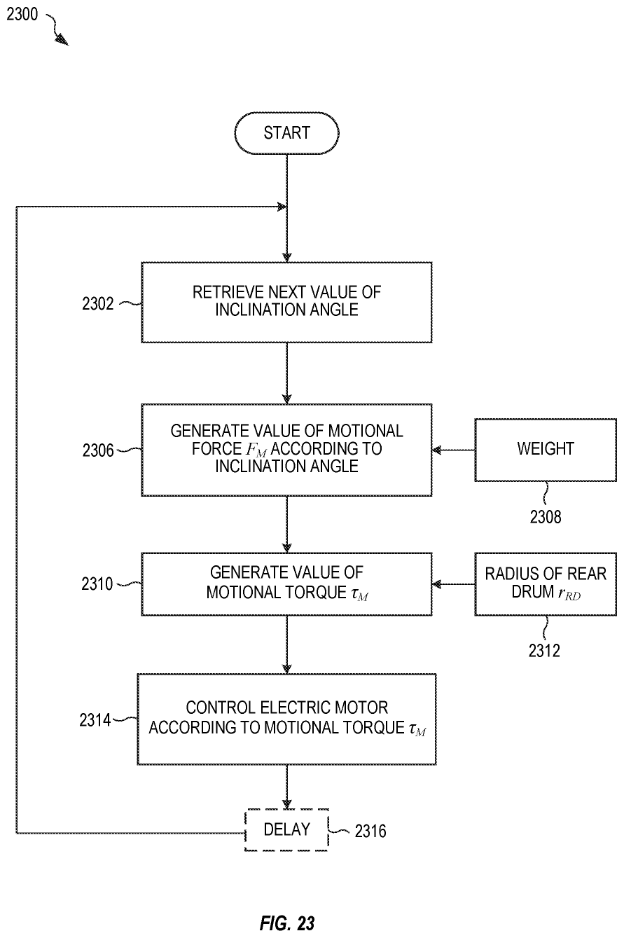

FIG. 23 is a flow chart illustrating a method 2300 for controlling a resistance generator (e.g., electric motor 1442) to simulate changing riding conditions. In the example of FIG. 23, controller 1434 stores a sequence of inclination angles corresponding to a bicycle course whose elevation changes along the course. In one section of the course corresponding to a positive inclination, controller 1434 may increase the resistance accordingly to simulate riding uphill. In another section of the course corresponding to a negative inclination, controller 1434 may decrease the resistance accordingly to simulate riding downhill. Sections of the course may also be simulated to have different strengths and directions of wind.

Method 2300 includes a step 2302 to retrieve the next value of the inclination angle. In one example of step 2302, controller 1434 accesses the next value of the inclination angle stored in the memory of controller 1434. Method 2300 also includes a step 2306 to generate a value of a motional force F_{M} according to the inclination angle. In one example of step 2306, controller 1434 multiplies a weight of bicycle 600 and the rider mounted thereon by the sine of the inclination angle. Method 2300 also includes a step 2308 that provides a value of the weight. As one example of step 2308, controller 1434 accesses a value of the weight stored in the memory of controller 1434.

Method 2300 also includes a step 2310 to generate a value of motional torque τ_{M} from the motional force F_{M}. In one example of step 2310, controller 1434 multiplies the value of motional force F_{M} by the value of the radius r_{RD} of rear drum 1404. Method 2300 includes a step 2312 to provide the value of r_{RD}. As one example of step 2312, controller 1434 accesses the value of r_{RD} stored in the memory of controller 1434.

Method 2300 also includes a step 2314 to control electric motor 1442 according to the value of the motional torque τ_{M}. In one example of step 2314, the processor of controller 1434 controls a digital-to-analog converter of controller 1434 that feeds a motor drive circuit (e.g., a PWM circuit) of controller 1434, the output of the motor drive circuit being electrically connected to electric motor 1442.

In one embodiment, method 2300 repeats steps 2302 through 2314 to periodically update the motional torque τ_{M} according to a different value of inclination angle. Method 2300 may also include a delay step 2316 to wait before repeating steps 2302 through 2314. In one example of step 2316, controller 1434 delays for 100 milliseconds. In another example of step 2316, controller 1434 monitors the speed of rear surface 1422 (e.g., the rotation rate of rear drum 1404) and computes a simulated distance traveled by the rider on bicycle 600; controller 1434 delays until the simulated distance has reached a value stored in the memory of controller 1434, wherein controller 1434 delays according to the simulated speed of bicycle 600, as generated by the rider.

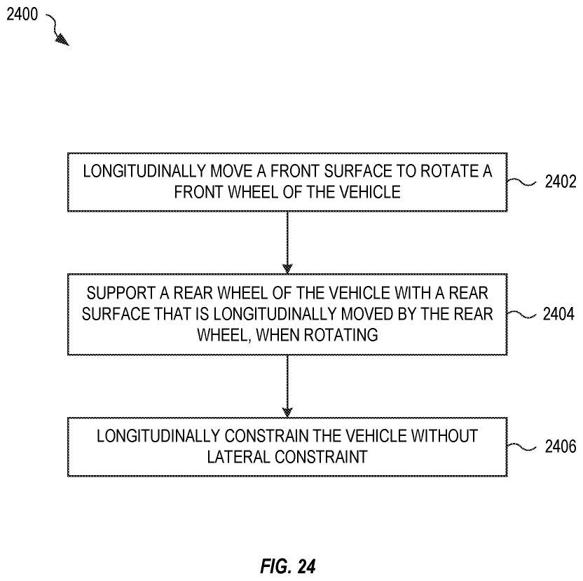

FIG. 24 is a flow chart illustrating a method 2400 to assist balancing of a human-supported vehicle. Method 2400 includes a step 2402 to longitudinally move a front surface, supporting a front wheel of the vehicle at a ground contact point of the front wheel, to rotate the front wheel such that the rotating front wheel translates laterally along the moving front surface to change a heading of a rear wheel of the vehicle in response to steering of the vehicle. As an example of step 2402, front roller 1402 is rotated by motor 1440 to longitudinally move front surface 1420 at front contact point 614, thereby rotating front wheel 604 of bicycle 600. Method 2400 also includes a step 2404 to support the rear wheel of the vehicle with a rear surface at a ground contact point of the rear wheel, wherein the rear surface is moved longitudinally by the rear wheel, when rotating, such that the rear wheel translates laterally along the moving rear surface in response to the change of heading. As an example of step 2404, rear surface 1422 of rear drum 1404 supports rear wheel 604 of bicycle 600 at rear contact point 616; as rear wheel 604 rotates in response to pedaling, rear surface 1422 is moved longitudinally by rotating rear wheel 604. Method 2400 also includes a step 2406 to longitudinally constrain the vehicle without lateral constraint. As an example of step 2406, longitudinal restraint mechanism 1408 longitudinally restrains bicycle 600 without lateral constraint.

Embodiments with Bicycle Trainers

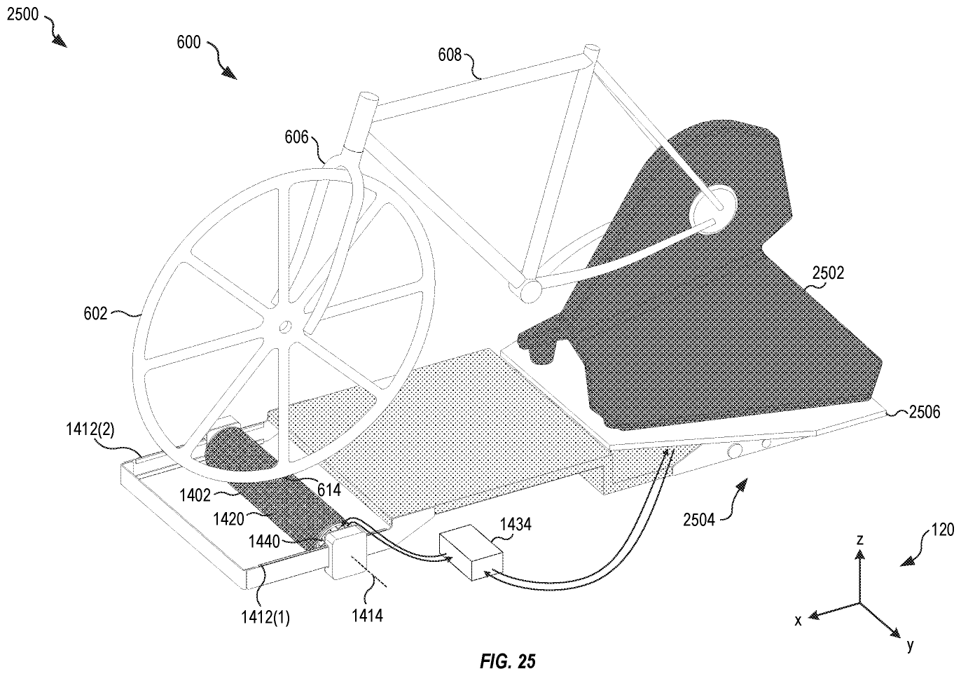

FIG. 25 is a perspective view of a vehicle simulator 2500 that works with bicycle 600 affixed to a stationary trainer 2502. In a conventional use scenario, stationary trainer 2502 is positioned at rest on the ground, with front wheel 602 neither rotating, changing heading, nor leaning. Compared to the conventional use scenario, simulator 2500 allows stationary trainer 2502 and front wheel 602 to move laterally, change heading, and lean, thereby advantageously providing to a rider of bicycle 600 a more realistic simulation of riding bicycle 600 on a road.

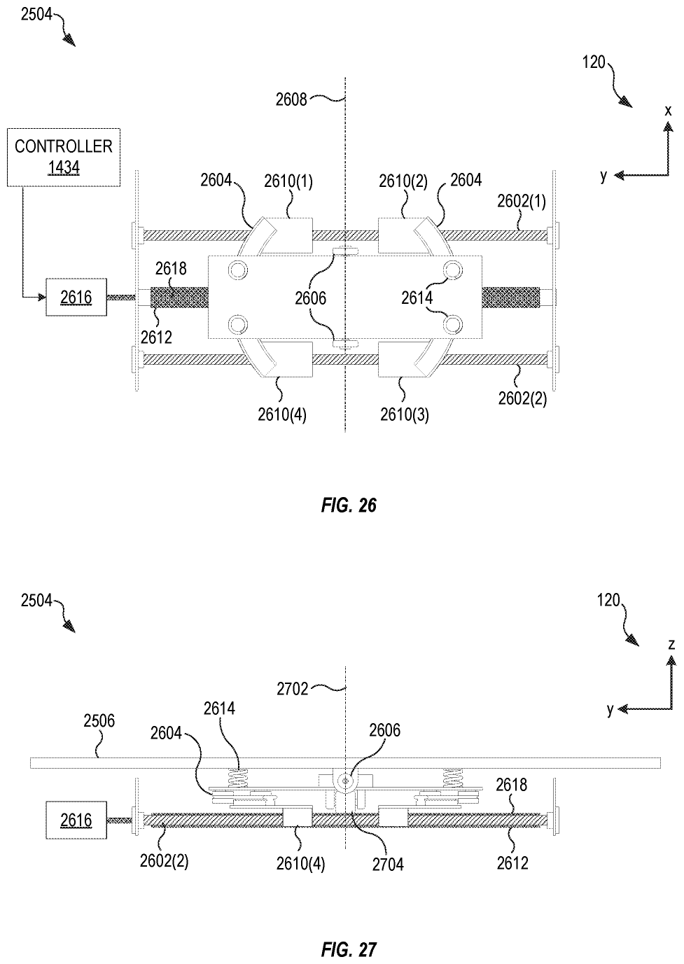

FIGS. 26 and 27 are top and rear views, respectively, of a rear translation mechanism 2504 that laterally moves a platform 2506 supporting stationary trainer 2502. Rear translation mechanism 2504 includes a rotatable transfer wheel 2704 affixed to a lower surface of platform 2506. Transfer wheel 2704 is supported by a rear drum 2612 that, when rotating, rotates transfer wheel 2704. In the example of FIGS. 26 and 27, rear drum 2612 is rotated by a motor 2616 controlled by controller 1434.

Rear translation mechanism 2504 also includes a turntable 2604 rotatable around a vertical turntable axis 2702, and a rolling-element bearing 2606 rotatable around a lean axis 2608. Turntable 2604 and rolling-element bearing 2606 are laterally centered such that turntable axis 2702 and lean axis 2608 intersect. Furthermore, transfer wheel 2704 is positioned to coincide with turntable axis 2702 beneath lean axis 2608, as shown in FIG. 27. Transfer wheel 2704 is oriented such that when platform 2506 has a zero heading angle and a zero lean angle, an axle of transfer wheel 2704 is parallel to the y axis (see coordinate system 120).

Simulator 2500 includes front roller 1402, described above for simulators 1400 and 1700 of FIGS. 14-19. Front roller 1402 is rotated (e.g., via motor 1440) to longitudinally move front surface 1420 to rotate front wheel 602 at front contact point 614. Rotating front wheel 602 laterally translates along moving front surface 1420 in response to steering of bicycle 600. That is, as bicycle 600 is steered (i.e., the front heading angle θ_{f} of front wheel 602 is changed), front wheel 602 laterally accelerates along moving front surface 1420.

Lateral motion of front wheel 602 moves fork 606 likewise, changing a heading of frame 608, stationary trainer 2502, and platform 2506 by rotating transfer wheel 2704, via turntable 2604, around turntable axis 2702. Transfer wheel 2704, when rotating about its axle, laterally translates along a longitudinally-moving rear surface 2618 of rear drum 2612 in response to the change of heading. That is, transfer wheel 2704 laterally accelerates along moving rear surface 2618.

Rear translation mechanism 2504 includes carriages 2610 that support turntable 2604 and are moveable along first and second linear guide rails 2602(1) and 2602(2). Thus, as transfer wheel 2704 laterally translates along rear surface 2618, rear translation mechanism 2504 laterally translates likewise along guide rails 2602 while preventing bicycle 600, stationary trainer 2502, and platform 2506 from moving longitudinally.

In one embodiment, rear translation mechanism 2504 includes a plurality of springs 2614 that provide a restoring force to return platform 2506 to a horizontal orientation (i.e., zero lean angle), thereby assisting the rider of bicycle 600 with balancing. In the example of FIGS. 26 and 27, four springs are shown, two laterally positioned on one side of lean axis 2608, and the remaining two laterally positioned on the other side of lean axis 2608. However, a different number of springs 2614 may be used without departing from the scope hereof. One end of each spring 2614 is affixed to the lower surface of platform 2506, with the other end affixed to a top surface of turntable 2604. The number, spring constant, and lateral positions of springs 2614 determine the size of the restoring force, and may be adjusted to alter a level of balance assistance to the rider. In one embodiment, springs 2614 are locked out such that platform 2506 may not lean around lean axis 2608. In another embodiment, rear translation mechanism 2504 does not include any springs, thereby providing no balance assistance to the rider. Each of springs 2614 may alternatively be an elastic band or another type of structure that obeys Hooke's law.

FIG. 25 shows simulator 2500 being used with a stationary trainer 2502 that replaces rear wheel 604. For example, stationary trainer 2502 may be a Tacx Neo Smart Trainer, a Wahoo KICKR Trainer, or similar type of stationary trainer known in the art. In another embodiment, stationary trainer 2502 does not replace rear wheel 604, in which case rear wheel 604 is affixed to bicycle 600 in the conventional manner. In this embodiment, stationary trainer 2502 may be a CycleOps Fluid or Magneto Trainer, a Kinetic Rock n Roll Trainer, or a similar type of stationary trainer known in the art.

To accurately replicate riding of bicycle 600 on a surface, stationary trainer 2502 may be positioned on platform 2506 such that a support axis of rear wheel 604 (see rear support axis 612 of FIG. 6) coincides with turntable axis 2702. In the example of FIG. 25, where bicycle 600 does not include rear wheel 604, stationary trainer 2502 may be positioned on platform 2506 such that a support axis of rear wheel 604 would coincide with turntable axis 2702 if rear wheel 604 were affixed to bicycle 600 in the conventional manner. Thus, when frame 608 changes heading in response to lateral motion of front wheel 602, platform 2506 rotates around turntable axis 2702 such that the heading of frame 608 (and rear wheel 604, when included) matches the heading of platform 2506.

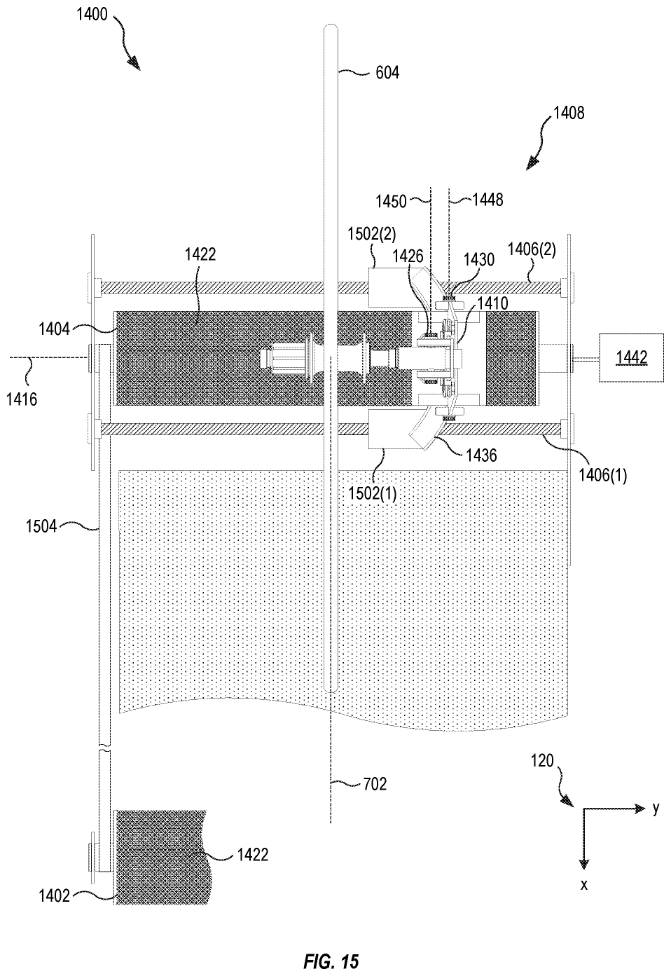

While FIGS. 25-27 show simulator 2500 operating with two motors (i.e., motor 1440 for rotating front roller 1402, and motor 2616 for rotating rear drum 2612), simulator 2500 may be alternatively configured with a drive belt (e.g., drive belt 1504 of FIG. 15) that connects front roller 1402 and rear drum 2612, wherein simulator 2500 may operate with only one of motors 1440 and 2616.

In some embodiments, simulator 2500 excludes rear drum 2612 and transfer wheel 2704, advantageously eliminating the need for motor 2616 to rotate rear drum 2612. In these embodiments, rear translation mechanism 2504 is supported only by guide rails 2602 via carriages 2610, and laterally translates along guide rails 2602 due to oscillatory leaning of bicycle 600 caused by pedaling. Specifically, when a rider pedals bicycle 600, the rider may control bicycle 600 to lean left-and-right in an oscillatory way that is synchronized with the rider's cadence. This oscillatory leaning can be observed, for example, when a cyclist rides out of the saddle during a sprint. By changing the amplitude of the oscillatory leaning (i.e., how far to the left and right the rider causes bicycle 600 to lean with each pedal stroke), the rider can control frame 608 to laterally translate, in turn causing the front heading angle of bicycle 600 to change. In response to this change of the front heading angle, rotating front wheel 602 laterally translates along moving front surface 1420. Thus, bicycle 600 can be balanced without steering, similarly to how a rider steers and balances a bicycle when riding without hands.

Electronics

FIG. 28 is a schematic diagram showing components and functionality of a controller 2800 that may be used with embodiments herein. Controller 2800 is one example of controller 820 of FIG. 8 and controller 1434 of FIGS. 14, 17, and 25-26. Controller 2800 includes a microprocessor circuit 2804 that processes data, and a memory 2806 that stores data 2810 and instructions 2808. Microprocessor circuit 2804, memory 2806, and other components of controller 2800 are communicatively coupled via a bus 2802. Controller 2800 may also include a graphical display 2830 that retrieves and displays information to the user (e.g., a rider of a vehicle used with a simulator being controlled by controller 2800). Graphical display 2830 may include a graphical user interface that allows the user to interact with controller 2800 (e.g., to enter information or change modes of operation). Controller 2800 may include an Ethernet port 2828 through which controller 2800 connects to a computer network (e.g., a network server via the Internet). Controller 2800 may also include an RF transceiver circuit 2820 electrically coupled with an antenna 2822 that wirelessly communicates with a remote computing device 2824 (e.g., a smartphone or laptop computer).

Controller 2800 includes a first sensor input circuit 2812 that receives a first sensor signal 2813 from a first sensor, and a second sensor input circuit 2814 that receives a second sensor signal 2815 from a second sensor. Each sensor may be an angle sensor (e.g., front and rear heading sensors 810(1), (2), front lean sensor 911), rotation sensor (e.g., rotation sensors 1446 and 1444), torque sensor (e.g., torque sensor 1452), orientation sensor (e.g., accelerometer), or other type of sensor. While FIG. 28 shows controller 2800 having two sensor input circuits 2812 and 2814 for use with two sensors, controller 2800 may be configured with a different number of sensor input circuits for use with a corresponding number of sensors.

Controller 2800 also includes a first controller circuit 2816 that outputs a first control signal 2817 to a first actuator, and a second control circuit 2818 that outputs a second control signal 2819 to a second actuator. Each actuator may be a linear actuator (e.g., front and rear actuators 808(1), (2) of FIG. 8), motor (e.g., motor 1440 of FIGS. 14, 17, and 25; motor 2616 of FIGS. 26 and 27; electric motor 1442 of FIG. 14), or other type of actuator. While FIG. 28 shows controller 2800 having two controller circuits 2816 and 2818 that control two actuators, controller 2800 may be configured with a different number of controller circuits that control a corresponding number of actuators.

Sensor input circuits 2812 and 2814 may amplify, filter, and/or digitize respective sensor signals 2813 and 2815. Depending on the type of sensor, each of sensor input circuits 2812 and 2814 may be configured for two-terminal sensing, four-terminal Kelvin sensing, a Wheatstone bridge, or another type of impedance, voltage, or current measurement technique. Sensor input circuits 2812 and 2814 may include difference amplifiers, instrumentation amplifiers, and/or similar components for analog signal conditioning. In some embodiments, sensor input circuits 2812 and 2814 include filters to reject noise and/or interference from respective sensor signals 2813 and 2815. When sensor signals 2813 and 2815 are analog signals, sensor input circuits 2812 and 2814 may include analog-to-digital converters (ADCs) to digitize respective sensor signals 2813 and 2815. When sensor signals 2813 and 2815 are digital signals, sensor input circuits 2812 and 2814 may include receivers to receive respective digital signals 2813 and 2815.

Depending on the type of actuator, each of controller circuits 2816 and 2818 may be configured to output an analog voltage or current, wherein the corresponding control signals 2817 and 2819 are analog control signals. Each of controller circuits 2816 and 2818 may be configured to output a digital signal, wherein the corresponding control signals 2817 and 2819 are digital control signals. In one embodiment, each of controller circuits 2816 and 2818 is a PWM circuit configured to drive a motor. In another embodiment, when each of controller circuits 2816 and 2818 is configured to output an analog signal, controller circuits 2816 and 2818 include a digital-to-analog converter (DAC) to generate corresponding analog control signals 2817 and 2819.

RF transceiver circuit 2820 may use one or more wireless protocols, such as Bluetooth, Wi-Fi, and ZigBee. In certain embodiments, RF transceiver circuit 2820 transmits wireless communication 2836 to remote device 2824 using any of several protocols that stream data over networks, such as User Datagram Protocol (UDP), Transmission Control Protocol (TCP), Hypertext Transfer Protocol (HTTP), Real-Time Streaming Protocol (RTSP), and Real-Time Transport Protocol (RTP). In certain embodiments, RF transceiver circuit 2820 may implement a Bluetooth profile such as Human Interface Device Profile (HID), Hands-Free Profile (HFP), LAN Access Profile (LAP), and a Bluetooth Advanced Audio Distribution Profile (A2DP). For example, RF transceiver circuit 2820 may use A2DP to stream front and rear heading angles θ_{f} and θᵣ via a single wireless channel to remote device 2824.

Microprocessor circuit 2804 may include at least one central processing unit (CPU), graphics processing unit (GPU), digital signal processor (DSP), field-programmable gate array (FPGA), or other type of integrated circuit capable of performing logic, control, and input/output operations. Microprocessor circuit 2804 may include a mixed-signal integrated circuit, such as a System-on-Chip (SoC) or microcontroller unit (MCU), that combines a processor, memory, and input/output interfaces on a single chip. Microprocessor circuit 2804 may also include a memory controller, bus controller, graphics processing unit, and/or other components that manage data flow between microprocessor circuit 2804, memory 2806, and other components communicatively coupled with bus 2802.

Memory 2806 may include both volatile memory (e.g., RAM, SRAM, etc.) and nonvolatile memory (e.g., ROM, FLASH, etc.). Instructions 2808 include machine-readable instructions that, when executed by microprocessor circuit 2804, control operation of controller 2800. Instructions 2808 may include at least one algorithm 2832, as well as operating system instructions. Algorithm 2832 is selected based on desired functionality of controller 2800, as described in further detail below.

In FIG. 28, memory 2806 is shown storing configuration data, speed v, front heading angle θ_{f}, rear heading angle θᵣ, a resistance model, front lateral velocity vᵣ and rear lateral velocity v_{y}^{(r)}. The configuration data may include values that define operation of instructions 2808 (e.g., for configuring algorithm 2832). The speed v may be a value inputted by a rider, or several values sensed by at least one of sensor input circuits 2812, 2814. Front and rear heading angles θ_{f} and θᵣ include values of heading angles sensed from corresponding front and rear heading angle sensors.

Microprocessor circuit 2804 executes instructions 2808 (e.g., algorithm 2832) to compute values of front and rear lateral velocities v_{y}^{(f)} and v_{y}^{(r)} from speed v and respective heading angles θ_{f} and θᵣ. Microprocessor circuit 2804 then sends values of front and rear lateral velocities v_{y}^{(f)} and v_{y}^{(r)} over bus 2802 to respective controller circuits 2816 and 2818, which output corresponding control signals 2817 and 2819 according to the received values of front and rear lateral velocities v_{y}^{(f)} and v_{y}^{(r)}, respectively. In one embodiment, microprocessor circuit 2804 sends values of lateral velocities v_{y}^{(f)} and v_{y}^{(r)} and/or heading angles θ_{f} and θᵣ over bus 2802 to RF transceiver circuit 2820 for transmission, via antenna 2822, to remote device 2824 as wireless communication 2836.

Controller 2800 may wirelessly transmit to remote device 2824 data stored in memory 2806. Remote device 2824 receives data in wireless communication 2836 and may display the received data to a user via a display 2838 of remote device 2824. In certain embodiments, remote device 2824 may store the received data for future processing and/or display. For example, controller 2800 may wirelessly transmit to remote device 2824 values of speed v of rear moving surface 1422, and corresponding values of time at which each value of speed v was sensed (e.g., by one of sensor input circuits 2812 and 2814); remote device 2824 may display these values on display 2838 as a rolling chart such that a rider may monitor speed v over time. When controller 2800 operates with a resistance generator, controller 2800 may wirelessly transmit to remote device 2824 values of the torque applied to electric motor 1442, along with corresponding values of time at which each torque was generated by electric motor 1442; remote device 2824 may display these values on display 2838 as a rolling chart such that a rider may observe changes in the simulated resistance force over time, thereby monitoring a level of effort required to overcome the resistance force.

In certain embodiments, RF transceiver circuit 2820 may also wirelessly receive, from remote device 2824 via antenna 2822, instructions and/or data to store in memory 2806. For example, the user may interact with an app running on remote device 2824 to modify values stored in data 2810. For example, when data 2810 includes values for a resistance model (e.g., a model of wind resistance or rolling resistance), the user may enter values for the normal force N, friction coefficient α, and/or coefficient C into remote device 2824, which wirelessly transmits the values to controller 2800 for storage in data 2810.

In some embodiments, controller 2800 is further configured such that a rider may participate in a massively multiplayer online game (MMOG), such as a massively multiplayer online racing (MMOR) game. As shown in the example of FIG. 28, controller 2800 communicates with a network server hosting the MMOG via Ethernet port 2828; controller 2800 may also communicate with the network server via other means, such as Wi-Fi, or cellular communication. In any case, the network server may transmit to controller 2800, via Ethernet port 2828, additional MMOG instructions 2834 and MMOG data to store in memory 2806. Microprocessor circuit 2804 may execute MMOG instructions 2834 to, for example, display to the rider via graphical display 2830 a virtual world in which the MMOG is played, including positions, orientations, and representations of other players in the virtual world. Microprocessor circuit 2804 may execute MMOG instructions 2834 to update values in data 2810 such that controller circuits 2816 and 2818 control simulators described herein according to physical features and phenomena (e.g., terrain, surface type, wind) of the virtual world. Microprocessor circuit 2804 may further execute MMOG instructions 2834 to transmit to the network server, via Ethernet port 2828, values stored in data 2810 that represent the simulated motion of the rider, wherein the network server redistributes these values to other players of the MMOG such that each player may see in their corresponding graphical display the correct positions and orientations of all players in the virtual world.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A vehicle simulator to assist balancing of a vehicle, comprising:
a front translation mechanism having a front surface that supports a front wheel of the vehicle, the front surface being longitudinally moveable to rotate the front wheel such that the front wheel, when rotating, laterally translates along the moving front surface in response to steering of the vehicle, wherein the front wheel, when laterally translating, changes a heading of a rear wheel of the vehicle;
a rear translation mechanism having a rear surface that supports the rear wheel and is longitudinally moveable by the rear wheel, when rotating, such that the rear wheel laterally translates along the moving rear surface in response to the change of heading; and
a longitudinal restraint mechanism configured to physically couple with the vehicle to longitudinally constrain the vehicle.

2. (canceled)

3. The vehicle simulator of claim 1, further comprising a linear guide that restrains movement of the longitudinal restraint mechanism to a lateral guide axis.

4. The vehicle simulator of claim 3, further comprising a drive belt mechanically coupled to move the front surface at a longitudinal speed similar to a longitudinal speed of the rear surface.

5. The vehicle simulator of claim 3, further comprising:
a motor physically coupled to longitudinally move the front surface;
a rear speed sensor that outputs a rear longitudinal speed signal in response to the rear surface moving;
a front speed sensor that outputs a front longitudinal speed signal in response to the front surface moving; and
a controller that receives the front and rear longitudinal speed signals and controls the motor to move the front surface according to the front and rear longitudinal speed signals.

6. The vehicle simulator of claim 5, the controller being configured to control the motor to move the front surface such that the front longitudinal speed signal follows the rear longitudinal speed signal.

7. The vehicle simulator of claim 5, further comprising a resistance generator that resists longitudinal motion of the rear surface.

8. The vehicle simulator of claim 7, the resistance generator comprising an electric motor physically coupled with the rear surface and controllable, by the controller, in a motoring mode and a generator mode.

9. The vehicle simulator of claim 8, further comprising a torque sensor that outputs a torque signal in response to a torque of the electric motor, wherein the controller is configured to control the electric motor such that the torque signal follows a torque setpoint.

10. The vehicle simulator of claim 9, the controller being further configured to algorithmically select the torque setpoint according to a model of a rolling resistance force between the rear wheel and a surface such that the torque simulates the rolling resistance force.

11. The vehicle simulator of claim 10, the controller being further configured to algorithmically select the torque setpoint according to a model of a drag force such that the torque simulates the drag force.

12. The vehicle simulator of claim 3, the vehicle being a bicycle and the longitudinal restraint mechanism comprising:
an arm having a variable length;
a top joint coupled with a top end of the arm and configured to physically couple with the bicycle, the top joint having a top axis parallel to a lean axis of the bicycle;
a bottom joint physically coupled with a bottom end of the arm and having a bottom axis parallel to the lean axis; and
a turntable that supports the linear guide and the bottom joint, and is rotatable about a vertically-oriented turntable axis in response to the changing heading;
wherein, when the bicycle leans, the arm pivots at the top axis and the bottom axis, and the length of the arm changes to allow the arm to remain parallel to a plane of the rear wheel.

13. The vehicle simulator of claim 12, wherein the turntable axis is aligned with a ground contact point of the rear wheel.

14. The vehicle simulator of claim 13, the top joint being configured to physically couple with an axle of the rear wheel.

15. The vehicle simulator of claim 13, the top joint being configured to physically couple with a frame of the bicycle.

16. The vehicle simulator of claim 13,
the front surface comprising a front roller; and
further comprising an adjustable spacer that longitudinally positions the front roller to support a ground contact point of the front wheel.

17-20. (canceled)

21. A vehicle simulator to assist balancing of a vehicle, comprising:
a front translation mechanism that supports a front portion of the vehicle and laterally translates the front portion to change a heading of a rear portion of the vehicle in response to steering of the vehicle, the front translation mechanism comprising:
a front carriage having a front joint configured to support the front portion, rotate about a front lean axis, and rotate about a front heading axis;
a steering sensor that senses a front heading angle of the front joint about the front heading axis; and
a front actuator that laterally translates the front carriage;
a rear translation mechanism that supports the rear portion and laterally translates the rear portion in response to the change of heading, the rear translation mechanism comprising:
a rear carriage having a rear joint configured to support the rear portion, rotate about a rear lean axis, and rotate about a rear heading axis; and
a rear actuator that laterally translates the rear translation mechanism;
a longitudinal restraint mechanism configured to physically couple with the vehicle to longitudinally constrain the vehicle; and
a controller configured to algorithmically determine front and rear lateral velocities based on the front and rear heading angles, respectively, and a nominal forward speed;
wherein the controller, in response to the steering of the vehicle, controls the front and rear actuators to laterally translate the respective front and rear carriages according to the respective front and rear lateral velocities.

22. The vehicle simulator of claim 21,
further comprising a front lean sensor that measures a front lean angle of the front joint around the front lean axis;
the controller being further configured to algorithmically determine a front lateral acceleration based on the front lean angle, and to control the front actuator to laterally accelerate the front carriage according to the front lateral acceleration.

23. The vehicle simulator of claim 22,
further comprising a rear lean sensor that measures a rear lean angle of the rear joint around the rear lean axis;
the controller being further configured to algorithmically determine a rear lateral acceleration based on the rear lean angle, and to control the rear actuator to laterally accelerate the rear carriage according to the rear lateral acceleration.

24. The vehicle simulator of claim 23, the controller including a switch that responds to an external signal to transition operation of the controller between an acceleration-based control mode and a velocity-based control mode.

25. The vehicle simulator of claim 21, wherein:
the vehicle is a bicycle;
the front joint is configured to support a front wheel of the bicycle; and
the rear joint is configured to support a rear wheel of the bicycle.

26. The vehicle simulator of claim 21, wherein:
the vehicle is a bicycle;
the front joint is configured to support a front fork of the bicycle; and
the rear joint is configured to support the rear portion of the bicycle via dropouts of the bicycle.

27-48. (canceled)
